(19) United States
(12) Patent Application Publication
(10) Pub. No.: US 2026/0115685 A1
(43) Pub. Date: Apr. 30, 2026

(54) CARBON BLOCK IMPREGNATED WITH TITANIUM (HYDR)OXIDES

(71) Applicant: Arizona Board of Regents on behalf of Arizona State University, Scottsdale, AZ (US)

(72) Inventors: Paul K. Westerhoff, Scottsdale, AZ (US); Alireza Farsad, Tempe, AZ (US); Kiril D. Hristovksi, Gilbert, AZ (US); Shahnawaz Sinha, Chandler, AZ (US)

(21) Appl. No.: 19/118,484

(22) PCT Filed: Oct. 6, 2023
(86) PCT No.: PCT/US2023/034629

§ 371 Date: Apr. 4, 2025

Related U.S. Application Data
(60) Provisional application No. 63/378,623, filed on Oct. 6, 2022.

(51) Int. Cl. B01J 20/20; B01J 20/06; B01J 20/28; B01J 20/32

(52) U.S. Cl. CPC B01J 20/20; B01J 20/06; B01J 20/28007; B01J 20/28016; B01J 20/28061; B01J 20/28073; B01J 20/3204; B01J 20/3217; B01J 20/3236

(57) ABSTRACT

A composite material includes an adsorbent support having a carbon block structure defining pores, and titanium (hydr)oxide particles or films bound to the carbon block structure inside the pores. Preparing the composite material includes contacting a porous support having a carbon block structure defining pores with a solution including a solvent and a titanium (hydr)oxide precursor to yield a precursor material, and drying the precursor material to yield a titanium (hydr)oxide-impregnated carbon block. Synthesizing hybrid titanium (hydr)oxides includes combining a solution including a titanium (hydr)oxide precursor and a solvent with one or more metal precursors to yield a precursor solution, and heating the precursor solution to yield the hybrid titanium (hydr)oxides.

### CROSS-REFERENCE TO RELATED APPLICATION

This application claims the benefit of U.S. Patent Application No. 63/378,623 filed on Oct. 6, 2022, which is incorporated by reference herein in its entirety.

### STATEMENT OF GOVERNMENT SUPPORT

This invention was made with government support under P42 ES030990 awarded by the National Institutes of Health. The government has certain rights in the invention.

### TECHNICAL FIELD

This invention generally relates amorphous titanium (hydr)oxide-impregnated carbon block, including methods of preparation, and use in removing metals, including arsenic, metalloids, or mixtures thereof, from water by adsorption/filtration.

### BACKGROUND

Activated carbon is used to remove organic pollutants from water. Agglomerated forms of activated carbon are produced as porous carbon block cartridges in point-of-use (POU) or point-of-entry (POE) systems. In some cases, the porous carbon block is functionalized for removal of pathogenic particles (bacteria, protozoa, etc.).

### SUMMARY

This disclosure relates to carbon block (CB) impregnated with amorphous titanium (hydr)oxides (THO) suitable for use as filters for the removal of metal contaminants, including arsenic, and metal mixtures from water. Suitable precursors for synthesizing titanium (hydr)oxides include titanium oxysulfate (TOS) or similar titanium oxycations, titanium isopropoxide (TTIP), titanium butoxide (TiBu), and other types of titanium salts. Other metals, such as ceria, can be added during synthesis to make hybrid ceria-titanium (hydr)oxides for added functionality, and to offer a broader range of metal oxidation states. These hybrid ceria-titanium (hydr)oxides are also considered THO within this disclosure. THO-impregnated carbon block can remove metals from water to reduce health risks of drinking water without sacrificing the capability of carbon block technology of removing organic contaminants from water.

Processes are described for the preparation of THO-impregnated carbon block with different degrees of THO crystallinity resulting in different arsenic removal capabilities. THO-impregnated carbon block with the highest percentage of amorphous THO structure display the best arsenic removal performance (i.e., highest arsenate adsorption capacity and fastest diffusion of arsenate from solution into the porous THO adsorbent carbon block). Arsenate is only a representative example of metals or oxo-anions/metalloids (e.g., arsenite, chromate, tungstate, vanadate, etc.). The THO-impregnated carbon block prepared using the disclosed processes exhibit a stable layer of THO that is resistant to leaching titanium out of the carbon block.

Although the inventive concepts include those defined in the attached claims, it should be understood that the inventive concepts can also be defined in accordance with the following embodiments.

Embodiment 1 is a composite material comprising:
an adsorbent support comprising a carbon block structure defining pores; and
titanium (hydr)oxide particles or films bound to the carbon block structure inside the pores.

Embodiment 2 is the composite material of embodiment 1, wherein a content of titanium in the composite material is about 1 wt % to about 20 wt %.

Embodiment 3 is the composite material of embodiment 2, wherein a content of titanium in the composite material is about 8 wt % to about 14 wt %.

Embodiment 4 is the composite material of any one of embodiments 1-3, wherein the titanium (hydr)oxide particles or films comprise amorphous titania.

Embodiment 5 is the composite material of embodiment 4, wherein the titanium (hydr)oxide particles or films comprise about 55 wt % to about 99 wt % amorphous titania.

Embodiment 6 is the composite material of any one of embodiments 1-5, wherein the titanium (hydr)oxide particles or films are free of semi-crystalline and crystalline titania.

Embodiment 7 is the composite material of any one of embodiments 1-6, wherein the titanium (hydr)oxide particles or films are distributed throughout the carbon block structure.

Embodiment 8 is the composite material of any one of embodiments 1-7, wherein the titanium (hydr)oxide particles or films are chemically bound to the carbon block structure.

Embodiment 9 is the composite material of any one of embodiments 1-8, wherein at least a portion of a surface of the carbon block structure and its pores is free of titanium (hydr)oxide particles.

Embodiment 10 is the composite material of any one of embodiments 1-9, wherein the titanium (hydr)oxide particles or films have an average diameter or thickness in a range of about 1 nm to about 500 nm.

Embodiment 11 is the composite material of embodiment 10, wherein the titanium (hydr)oxide particles or films have an average diameter or thickness in a range of about 20 nm to about 50 nm.

Embodiment 12 is the composite material of any one of embodiments 1-11, wherein a majority of the pores in the composite material have an average diameter greater than 2 nm and less than 50 nm.

Embodiment 13 is the composite material of any one of embodiments 1-12, wherein a pore volume of the composite material is between about 0.05 cm³/g and about 0.08 cm³/g, based upon BJH model fitting.

Embodiment 14 is the composite material of any one of embodiments 1-13, wherein a BET surface area of the composite material is between about 350 m²/g and about 450 m²/g.

Embodiment 15 is the composite material of any one of embodiments 1-14, wherein an arsenic adsorption capacity of the composite material is in a range of about 5 milligrams arsenic per gram of titanium to about 10 milligrams arsenic per gram of titanium.

Embodiment 16 is the composite material of any one of embodiments 1-15, further comprising cerium-titanium (hydr)oxide particles or films bound to the carbon block structure inside the pores.

Embodiment 17 is a method of preparing composite material, the method comprising: contacting a porous support comprising a carbon block structure defining pores with a solution comprising a solvent and a titanium (hydr)oxide precursor to yield a precursor material; and drying the precursor material to yield a titanium (hydr)oxide-impregnated carbon block.

Embodiment 18 is the method of embodiment 17, wherein the titanium (hydr)oxide precursor comprises titanium oxysulfate, titanium isopropoxide, or titanium butoxide.

Embodiment 19 is the method of embodiment 17 or 18, wherein the solvent comprises ethanol.

Embodiment 20 is the method of any one of embodiments 17-19, further comprising adjusting a pH of the solution with an acid to yield a gel.

Embodiment 21 is the method of any one of embodiments 17-20, further comprising subjecting the precursor material to a vacuum to distribute the titanium (hydr)oxide precursor throughout the pores.

Embodiment 22 is the method of embodiment 21, further comprising heating the solution.

Embodiment 23 is the method of embodiment 22, wherein heating the solution comprises sealing the porous support in a bag and heating the contents of the bag to a constant temperature.

Embodiment 24 is the method of embodiment 22 or 23, further comprising washing the precursor material to yield a washed precursor material.

Embodiment 25 is the method of embodiment 24, further comprising drying the washed precursor material to yield a dried precursor material.

Embodiment 26 is the method of embodiment 25, further comprising neutralizing the dried precursor material with a basic solution to yield a neutralized precursor material.

Embodiment 27 is the method of embodiment 26, further comprising drying the neutralized precursor material.

Embodiment 28 is the method of any one of embodiments 17-27, wherein the solution further comprises a cerium precursor or a cerium (hydr)oxide precursor.

Embodiment 29 is a method of synthesizing hybrid titanium (hydr)oxides, the method comprising:
combining a solution comprising a titanium (hydr)oxide precursor and a solvent with one or more metal precursors to yield a precursor solution, wherein the one or more metal precursors comprise metal oxycations, metal isopropoxides, metal butoxides, metal salts, or a combination thereof; and
heating the precursor solution to yield the hybrid titanium (hydr)oxides.

Embodiment 30 is the method of embodiment 29, wherein the one or more metal precursors comprise cerium precursors.

Embodiment 31 is the method of embodiment 29 or 30, further comprising adjusting the pH of the solution with a base.

Embodiment 32 is the method of any one of embodiments 29-31, further comprising drying the hybrid titanium (hydr)oxides.

Embodiment 33 is the method of any one of embodiments 29-32, wherein the solvent comprises water, acetic acid, ethanol, or a combination thereof.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIGS. 1 and 2 are flow charts including operations and materials used in the preparation of titanium (hydr)oxide-impregnated carbon block.

FIG. 3 shows a plot of arsenic removal breakthrough curves for different unmodified and impregnated carbon block. Experimental conditions: Background matrix: Deionized water (DI), arsenate concentration C₀(As(V))=100 μg/L, para-chlorobenzoic acid concentration C₀(pCBA)=300 μg/L, pH=6.3, Temperature=22±1° C.

FIG. 4 shows a plot of pCBA breakthrough curves for titanium isopropoxide-ethanol carbon block (TTIP-EtOH CB), titanium butoxide-ethanol carbon block (TiBu-EtOH CB): pCBA breakthrough curves at conductivity=1314 μS/cm and pH=7.8, and comparison with unmodified carbon block performance. Experimental conditions: Background matrix: Tap water, C₀(As(V))=100 μg/L, C₀(pCBA)=300 μg/L, Temperature=22±1° C.

FIGS. 5A and 5B show X-ray diffractometry (XRD) patterns of titanium (hydr)oxide (THO)-impregnated carbon block (CB) and THO powders formed outside the carbon block, respectively. In the peaks' labels, “A” refers to Anatase and “R” refers to Rutile phases.

FIG. 6A shows arsenate breakthrough curves of TTIP-EtOH carbon block in intermittent and continuous modes. Background matrix: DI water containing arsenate (100 μg/L), pCBA (300 μg/L) at an influent of pH=6.3 and 22±1° C. Experimental conditions: empty bed contact time (EBCT)=0.28 min, hydraulic loading rate=4.5 m³/m²·hr. FIG. 6B shows plots of arsenate (As(V)) and arsenite (As(III)) breakthrough curves for TTIP-EtOH carbon block in continuous operation mode. Background matrix: DI water containing arsenate (100 μg/L) or arsenite (100 μg/L), at an influent of pH=6.3 and 22±1° C. EBCT=17 seconds.

FIG. 7 shows Fourier transform infrared (FT-IR) spectra of unmodified and impregnated carbon block (CB).

FIGS. 8A and 8B show plots of experimental data (symbols) and pore surface diffusion model (PSDM) predictions (lines) for arsenate breakthrough using TTTP-EtOH carbon block and TiBu-EtOH carbon block, respectively.

FIGS. 9A and 9B show pollutant breakthrough curves for unmodified, TTIP-EtOH, or TiBu-EtOH carbon block (CB) in different water matrices. FIG. 9A shows arsenate breakthrough curves at conductivity=1314 μS/cm and pH=7.8, and FIG. 9B shows arsenate breakthrough curves at conductivity=139 μS/cm and pH=7.6.

FIG. 10 shows XRD spectra of different CTHO powders and the reference THO powder formed ex-situ to the carbon block. In the peaks' labels, “A” and “R” refer to the anatase and rutile phases of titania, respectively, and the peaks without a letter direct to ceria crystalline peaks.

FIG. 11 shows the sum of oxo-anions adsorption capacity for different ex-situ synthesized THO and CTHO adsorbents obtained from pseudo-equilibrium batch experiments (with [As(V)]₀=[V(V)]₀=[W(VI)]₀=[Cr(VI)]₀=[Se(VI)]0=13.5 μM, initial pH=6.3±0.1, and temperature=22±1° C.).

FIG. 12 shows the cumulative and individual ratios of Ti(III)/Ti(IV) and Ce(III)/Ce(IV) chemical states in different ex-situ synthesized CTHO materials before and after oxo-anion adsorption through batch removal tests.

FIG. 13 depicts carbon block dimensions and Sous vide impregnation procedure.

FIG. 14 shows XRD spectra of the produced THO using Sous vide and conventional autoclave approaches compared with a reference TiO₂.

FIG. 15A shows arsenic breakthrough curves for THO-impregnated carbon block in tap water spiked with C₀(As)=100 μg/L and C₀(As)=10 μg/L, conductivity=1,368 μS/cm and pH=7.9, EBCT=0.48 min and T=23±1° C. FIG. 15B shows Se, V, Fe, and As breakthrough curves for THO-impregnated carbon block in actual groundwater with C₀(As)=36 μg/L, C₀(V)=6 μg/L, C₀(Se)=9 μg/L, C₀(Fe)=7 μg/L, conductivity=1,132 μS/cm and pH=8.2, EBCT=0.48 min, and T=23±1° C.

### DETAILED DESCRIPTION

This disclosure relates to carbon block (CB) impregnated with amorphous titanium (hydr)oxides (THO) suitable for use as filters for the removal of metal contaminants, including arsenic, and metal mixtures from water. Suitable precursors for synthesizing titanium (hydr)oxides include titanium oxysulfate (TOS) or similar titanium oxycations, titanium isopropoxide (TTIP), titanium butoxide (TiBu), and other types of titanium salts. Other metals, such as ceria, can be added during synthesis to make hybrid ceria-titanium (hydr)oxides for added functionality, and to offer a broader range of metal oxidation states. These hybrid ceria-titanium (hydr)oxides are also considered THO within this disclosure. THO-impregnated carbon block can remove metals from water to reduce health risks of drinking water without sacrificing the capability of carbon block technology of removing organic contaminants from water.

Processes are described for the preparation of THO-impregnated carbon block with different degrees of THO crystallinity resulting in different arsenic removal capabilities. THO-impregnated carbon block with the highest percentage of amorphous THO structure display the best arsenic removal performance (i.e., highest arsenate adsorption capacity and fastest diffusion of arsenate from solution into the porous THO adsorbent carbon block). Arsenate is only a representative example of metals or oxo-anions/metalloids (e.g., arsenite, chromate, tungstate, vanadate, etc.). The THO-impregnated carbon block prepared using the disclosed processes exhibit a stable layer of THO that is resistant to leaching titanium out of the carbon block.

Modifying carbon block through impregnation of cerium-titanium (hydr)oxide (CTHO) into its pores was shown to form different amorphous materials that could in batch and continuous flow tests achieve simultaneous removal of multiple oxo-anions (arsenic, vanadate, tungstate, chromate, and selenate) from water. Four synthesis techniques produced varying amorphous structures ex-situ or in-situ to carbon block. A sol-gel-derived amorphous CTHO (referred to as Ceₐₗₖ TIP), synthesized using titanium and cerium isopropoxides, acetic acid, and ethanol, exhibited superior performance with a twofold increase in oxo-anion removal capacity compared to the reference titanium (hydr)oxide (THO). The oxygen content of the derived CTHOs alone was insufficient to predict oxo-anions' adsorption capacity. However, the presence of reduced titanium and cerium chemical (III)/(IV) oxidation states, indicating the presence of oxygen vacancies, significantly enhanced the oxo-anion removal capacity. Ceₐₗₖ TIP, with amorphous phases of both titanium and cerium, exhibited the highest (III)/(IV) ratios and demonstrated superior performance in oxo-anion removal.

This disclosure also describes impregnation of a commercially available full-size carbon block filter with amorphous THO using a Sous vide technique to synthesize amorphous THO directly within the carbon block. A series of characterization tests were conducted to assess the efficiency of the impregnation process using Sous vide and to compare the crystallinity of the resulting THO with a conventional autoclave synthesis method. The impregnated carbon blocks were utilized for POU arsenic removal from tap water spiked with arsenic and actual groundwater samples.

### EXAMPLES

### Example 1

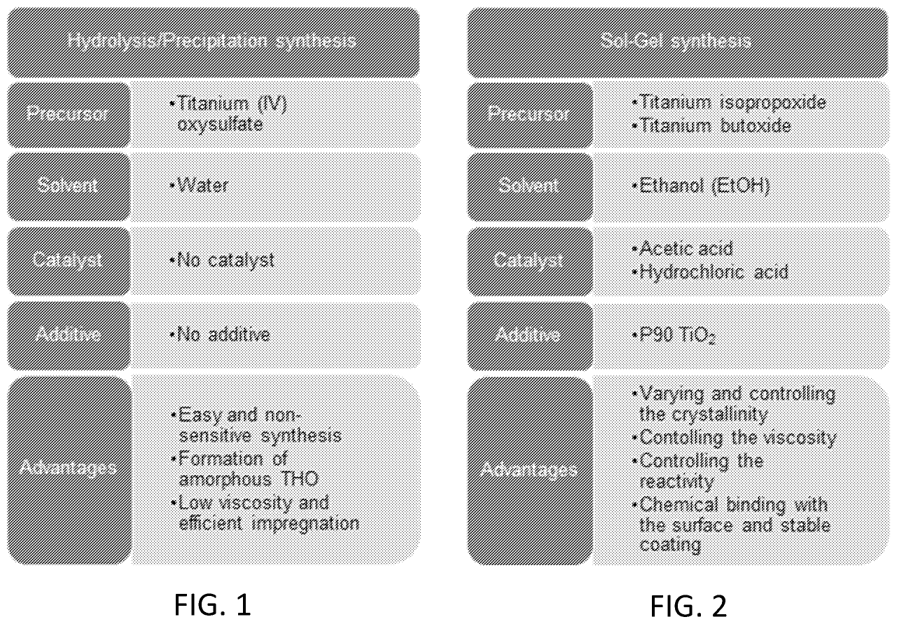

Two methods were used for the preparation of THO-impregnated carbon block: the hydrolysis/precipitation method depicted in FIG. 1 and the sol-gel in-situ method depicted in FIG. 2. While the hydrolysis/precipitation preparation method used titanium oxysulfate as a precursor, other similar salts could be used in the same procedure as well. Titanium isopropoxide (TTIP) and titanium butoxide (TiBu) were used as precursors for the sol-gel preparation method. Both methods used for impregnation of the carbon block involve in-situ formation of the THO particles inside the carbon block pores. Each preparation method starts with mixing determined ratios of precursors, solvents, and probable catalysts and additives, followed by removing the trapped oxygen inside the carbon block and introducing the synthesis solution into the pores of the carbon block. The preparations are completed through different aging, drying, and washing steps. The disclosed preparation and impregnation techniques involve chemical binding between the formed THO and carbon block that results in a stable coating. Controlled viscosity and reactivity of the precursors and synthesis solutions make the methods efficient for impregnation of a porous media like carbon block, producing an even distribution of the particles and coating layer.

The disclosed techniques allow the use of different preparation agents and conditions to control the crystallinity of the resultant THO and its amorphous content, and do not adversely affect the intrinsic characteristics of the carbon block. Thus, the impregnated carbon block is an efficient adsorbent for arsenic, other oxo-anions, and metals mixtures that can still remove organics effectively. The preparation methods depicted in FIGS. 1 and 2 were used to produce powders of THO in addition to impregnating them into the carbon block for further chemical and physical analysis, characterization, and to conduct batch adsorption experiments.

As a representative carbon block structure, ICEPURE® carbon block (10″ length×4.5″ diameter, with an average particle size of 5 μm) was characterized to confirm the absence of any background titanium. A variety of carbon blocks from other suppliers are also suitable. The carbon block was then cut into cylindrical pieces for laboratory scale tests of impregnation and arsenic removal. A drilling tool was used to cut smaller pieces from this carbon block with a height and diameter of 22 mm (0.86″) and 32 mm (1.25″), respectively (a bed volume of 17 cm³). These dimensions were selected to stay consistent with the hydraulic loading rates (HLR) commonly used in point-of-use (POU) systems. The carbon block pieces were then impregnated with THO by removing the trapped oxygen from the structure of the carbon block under vacuum and placing the carbon block inside the synthesis solution containing the mixture of precursor, solvent, and probable catalyst and additive. Finally, the impregnated carbon block was aged, dried, and washed, as provided in example workflows below.

The following description details the hydrolysis/precipitation method for transforming commercially available carbon block for arsenic and oxo-anions removal. An aqueous solution of titanium (IV) oxysulfate (TOS) was prepared with deionized (DI) water in a concentration of 250 g/L by stirring at room temperature until a clear solution was obtained. The carbon block was soaked in the solution and vacuum was applied on the surface of the carbon block to accelerate the solution uptake. This was followed by stirring the solution at 80° C. for 3 hr. The impregnated carbon block was then washed and dried at 60° C. overnight. As a flexible design parameter, higher or lower temperatures can be used because this influences the kinetics of titanium (hydr)oxide material deposition and growth into the carbon block pores. The impregnated carbon block was then treated by passing a 10 mM solution of sodium bicarbonate through the carbon block for neutralization, followed by another drying step at 60° C. The product of this procedure is referred to herein as TOS CB.

Referring to FIG. 2, three different THO batches were prepared in the sol-gel preparation process. In the one batch, 22 mL of titanium butoxide (TiBu) was added to 50 mL EtOH and stirred at 80° C. for 3 hr. Afterwards, to adjust the pH of the solution for better gelation, a 7 mL solution of 6 M HCl was added to the solution. After 3 min of stirring at 80° C. the carbon block piece was placed in the solution and a vacuum was applied. As a flexible design parameter, higher or lower temperatures can be used, at least because the temperature influences the kinetics of titanium (hydr)oxide material deposition and growth into the carbon block pores. The entire solution including the carbon block was then transferred into a 125 mL Teflon lined autoclave that was sealed and capped tightly inside a stainless-steel holder and put in the oven at 80° C. for 20 hr. After removal from the autoclave, the impregnated carbon block was removed from the formed gel and sequentially washed with DI water and ethanol. The impregnated carbon block was dried at 60° C. overnight. As a flexible design parameter, higher or lower temperatures can be used at least because this influences the kinetics of titanium (hydr)oxide material deposition and growth into the carbon block pores. The product of this procedure is referred to herein as TiBu-EtOH CB.

Using the same sol-gel preparation procedure, another sample was prepared with a slight modification: 10 mol % commercial Degussa P90® powder was added to the solution as a filler Other steps in the preparation were kept the same. The product of this procedure is referred to herein as P90-filled CB.

Another batch was prepared using the sol-gel preparation procedure by the addition of 20.2 mL titanium isopropoxide (TTIP) to 22.8 mL acetic acid and stirring for 75 min at room temperature. As a flexible design parameter, these feedstock solution concentrations can be used at least because this influences the kinetics of titanium (hydr)oxide material deposition and growth into the carbon block pores. Then 25 mL ethanol was added to the solution with stirring for 5 min, followed by soaking the carbon block inside the clear transparent solution with a vacuum applied on its surface. The solution and carbon block were then transferred to a well-sealed Teflon autoclave and heated at 80° C. for 20 hr. The impregnated carbon block was then taken out of the autoclave, sequentially washed with DI water and EtOH, and dried at 60° C. overnight. The product of this procedure is referred to herein as TTIP-EtOH CB. Table 1 summarizes synthesis conditions for the fabricated sorbents and their acronyms. Other types of alcohols and acidic catalysts could also be used for the sol-gel synthesis by different organic titanium precursors.

TABLE 1
Data for different THO synthesis methodologies
and assigned acronyms.

| Material | | | Other used |
|---|---|---|---|
| acronym | Synthesis method | Precursor | reagents |
| TTIP-EtOH | Sol-gel | Titanium isopropoxide | Acetic acid, |
| | | | Ethanol |
| TiBu—EtOH | Sol-gel | Titanium butoxide | HCl, Ethanol |
| P90-filled | Sol-gel | Titanium butoxide | HCl, Ethanol, |
| | | | P90 |
| TOS | Hydrolysis/ | Titanium oxysulfate | DI Water |
| | Precipitation | | |

Thus, four different preparation methods were employed that resulted in controllable and stable impregnation of different grades of THO with different amorphous contents into carbon blocks. X-ray diffractometry (XRD) was used to assess how each preparation method controlled the chemical structure and amorphous content of the prepared THO. Scanning electron microscopy (SEM) and energy-dispersive X-ray spectroscopy (EDX) were used to evaluate the effectiveness of the impregnation by each method. Liquid nitrogen physisorption experiments were performed to measure the surface area and pore size distribution of the unmodified and modified carbon block using Brunauer-Emmett-Teller (BET) and Barrett-Joyner-Halenda (BJH) models, respectively. SEM images illustrate that the preparation techniques lead to an impregnation of the carbon block with different grades and sizes of THO particles that do not block the pores of the carbon block. It is observed that the coating layer is evenly distributed over the structure of the carbon block.

The strategy for synthesizing Ce—Ti mixed metal (hydr)oxides was to add cerium to a synthesis procedure that results in amorphous titanium. By addition of appropriate cerium precursor to the syntheses of amorphous titanium (hydr)oxide, formation of Ce—Ti binary (hydr)oxide was studied. Two different methods of hydrolysis plus precipitation using TOS and sol-gel using TTIP, which result in formation of amorphous THO, were used to synthesize Ce-THO by addition of cerium (IV) isopropoxide or ammonium cerium (IV) nitrate.

In a hydrolysis/precipitation method, 250 g/L of TOS was added to DI water and stirred at ambient temperature. After getting a clear solution, an aqueous solution of ammonium cerium (IV) nitrate was added to the solution and pH was adjusted to be either 7 or 9 by using NaOH. The solution was then heated at 80° C. for 3 hr. to get a homogenous yellow solution. The solution was kept at an oven at 60° C. overnight to dry.

In a sol-gel synthesis using TTIP, three different strategies were followed to add cerium to the solution, including using a cerium alkoxide, a cerium salt, or a commercial CeO₂. The first step was almost identical for all the three approaches. Briefly, 20.2 mL TTIP was added to 22.8 mL acetic acid and stirred for 75 min at room temperature. In the case of using cerium alkoxide, 3 g cerium (IV) isopropoxide was added to the mixture of TTIP and acetic acid from the beginning followed by addition of 25 mL EtOH to the solution after 75 min of stirring. However, for the other two approaches, cerium precursor was mixed with EtOH and added to the titania solution. So, respectively, 7.2 g ammonium cerium (IV) nitrate, or 2.3 g commercial CeO₂ was added to 25 mL EtOH to synthesize two different grades of Ce—Ti(hydr)oxide. After addition of EtOH, the solutions were stirred for 10 min and transferred to a Teflon lined autoclave inside a well-sealed stainless-steel holder. The solutions were aged for 20 hr at 80° C. inside an oven, followed by drying at 60° C. overnight.

The carbon blocks were impregnated with Ce—Ti(hydr)oxide. Briefly, ICEPURE carbon blocks (10″×4.5″, 5 μm) were used because they do not initially hold any content of Ti or Ce. The carbon block was cut into small cylinders with a diameter of 32 mm and height of 22 mm to make it manageable for bench-scale column tests. The impregnation experiments were identical for all the mentioned Ce—Ti(hydr)oxide syntheses. After preparing the final solutions mentioned above, vacuum was applied on the cut piece of carbon block and it was simultaneously inserted into the solution. So, the trapped air was pulled out of the structure of the carbon block and synthesis solution was pushed into the pores. After 10 min of vacuuming, the carbon block inside the solution was inserted into a Teflon sealed autoclave followed by the mentioned aging and drying steps for the sol-gel process. After drying, the impregnated carbon block was washed with ethanol and water followed by neutralization using 10 mM solution of sodium bicarbonate.

The four described preparation methods achieved about 8 wt % to 15 wt % Ti loading within carbon block with amorphous titania content varying between 58% and 97%. These impregnations resulted in even distribution of THO particles without coverage of the whole carbon surface (which allows efficient removal of organics) or without causing any clogging of the pores (which prevents causing operational pressure drop). The resultant impregnated carbon blocks were used in continuous flow experiments to assess arsenic removal. Dynamic flow tests of arsenate removal by both unmodified and THO-impregnated carbon block were performed in parallel to investigate mass transport and adsorption capacity limitations. Several characterization techniques were employed to interpret the performance of the impregnated carbon block and to gain mechanistic understanding into the factors controlling the arsenic removal. Testing the impregnated carbon block through dynamic continuous flow regime showed the carbon block ability for arsenic removal after impregnation, while the unmodified carbon block did not remove any arsenic from the matrix. A sol-gel-prepared TTIP-EtOH carbon block that had the most amorphous THO content had the best arsenic removal performance (i.e., lowest residual arsenate and highest adsorption capacity) compared with semi-crystalline THO structures impregnated into carbon block. Because all impregnated carbon block tested had comparable surface area and pore size distribution, the differences in performance can be attributed to the chemical properties of the THO. Thus, TTIP-EtOH carbon block displaying the best performance can be explained by this sample having the highest percentage of amorphous THO.

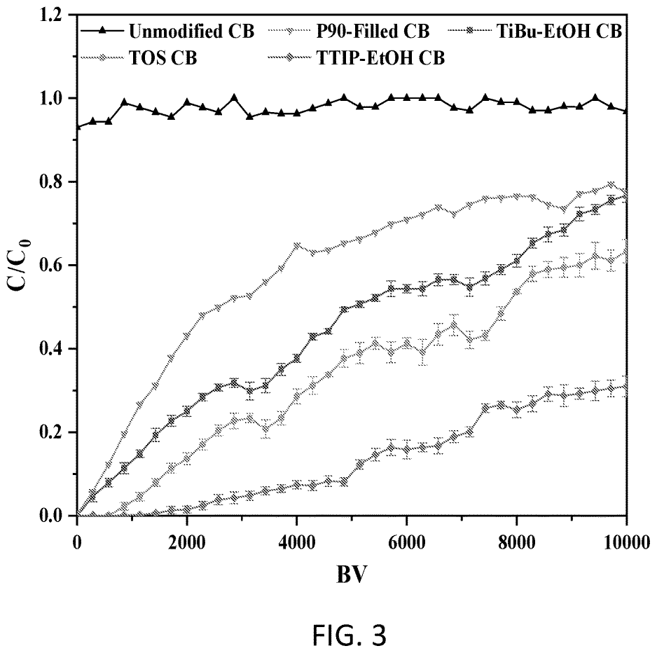

FIG. 3 shows the arsenic breakthrough curves for both unmodified and THO-impregnated carbon block. Arsenic breakthrough at 10,000 bed volumes (BV) of treated water was used as a benchmark for comparison of the treatment performance, which translates into a representative treatment capacity for carbon block in POU applications (i.e., 5,000 to 10,000 liters for carbon block having a 1-L capacity). The instantaneous arsenic breakthrough for the unmodified carbon block demonstrates that it does not remove arsenic from water. In contrast, impregnating THO into carbon block improves arsenic removal performance without significantly increasing the pressure drop. The pressure drop for all impregnated and unmodified carbon block was below 5 psi. This small difference in the pressure drops (<10%) suggests that the THO impregnation did not impact the hydraulic performance of the modified carbon block. FIG. 3 also shows the amorphous TTIP-EtOH carbon block achieved the best arsenic removal capacity, followed by TOS, TiBu-EtOH and P90-filled carbon block, respectively. The Ti-normalized arsenic adsorption capacity ranges from 5.7 to 8.1 mg As/g Ti, with the amorphous TTIP-EtOH carbon block achieving the highest adsorption capacity and nearly 40% better than the crystalline-based P90-filled CB. All the chemically prepared THO impregnation methods performed better compared to P90-filled carbon block that contains a commercial crystalline TiO₂. FIG. 3 indicates the carbon block impregnated with the highest amorphous THO content have the best performance in removal of arsenic as compared to the adsorbents with semi-crystalline THO structures. These results suggest that increasing the degree of crystallinity of the impregnated THO results in decreased arsenic adsorption capacity, and that amorphous THO structures are better adsorbents with higher capacity for removal of arsenic. TTIP-EtOH, as the most amorphous THO, can be impregnated into carbon block for simultaneous removal of different oxo-anions/metaloids (e.g., oxo-anions of arsenic, chromium, vanadium, and tungsten) and metals (e.g., lead, copper, zinc).

Table 2 summarizes the adsorption capacities normalized and not normalized to Ti-loading after 10,000 BV of operation. To evaluate the textural properties of the unmodified and impregnated carbon blocks and to assess the accessible adsorption sites, surface area and pore size distributions were determined using Brunauer-Emmett-Teller (BET) and Barrett-Joyner-Halenda (BJH) models, respectively, fitting on a Tristar II Plus instrument (Micromeritics, USA).

TABLE 2
Specifications of the impregnated carbon block and their arsenate adsorption capacities per weight
of carbon block and Ti content calculated for the first 10,000 BV treated. (Concentration: 100
μg As(V)/L, 300 μg pCBA/L, initial pH = 6.3, EBCT = 0.28 min, loading rate = 4.5 m³/m² · hr)

| | As(V) adsorption | | | | As(V) adsorption capacity |
|---|---|---|---|---|---|
| | capacity | | Ti content and | % Pore | from tap water with |
| THO-Impregnated | (mg/g Ti) (mg/g | | BET surface | distribution | conductivity of 139 μS/cm |
| carbon block (CB) | CB) | | area | (micro:meso:macro) | and 1314 μS/cm |
| Unmodified CB | <0.001 | (0.027) | 1 wt % | 39:57:4 | NA |
| | | | 571 m²/g | | |
| P90-filled CB | 5.7 | (0.49) | 8.6 wt % | 28:67:5 | NA |
| | | | 447 m²/g | | |
| TiBu—EtOH CB | 6.9 | (0.64) | 9.3 wt % | 16:79:5 | 5.8 mg/g Ti |
| | | | 393 m²/g | | 3.9 mg/g Ti |
| TOS CB | 7.2 | (0.87) | 12.2 wt % | 24:72:4 | NA |
| | | | 410 m²/g | | |
| TTIP-EtOH CB | 8.1 | (1.3) | 15.9 wt % | 33:61:6 | 6.1 mg/g Ti |
| | | | 363 m²/g | | 4.1 mg/g Ti |

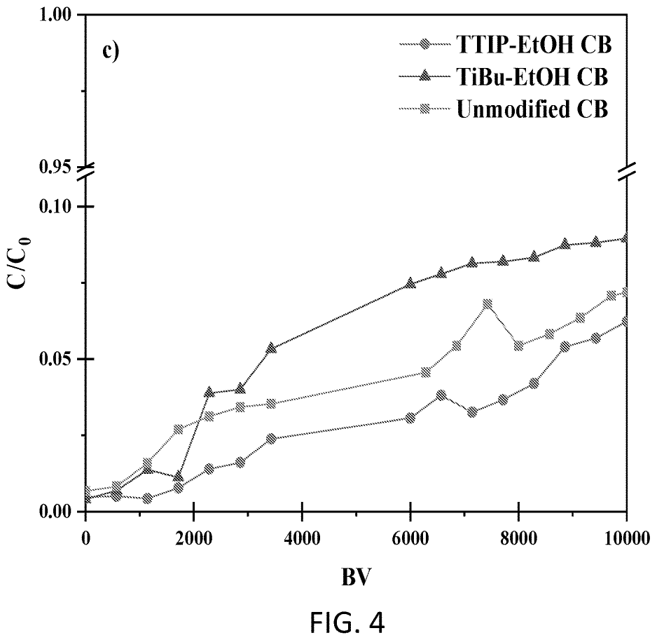

FIG. 4 shows the performance of the TTIP-EtOH and TiBu-EtOH carbon block samples with the highest and lowest chemically synthesized THO content. The plots in FIG. 4 are breakthrough curves for para-chlorobenzoic acid (pCBA, an example for chlorinated polar organic compounds) using tap water as the water source. This test shows that the THO impregnation of carbon block does not adversely affect its capability for organics removal. Without THO impregnation, the carbon block outputs low amounts of pCBA (C/C₀<0.1) in the effluent with due to the high pCBA adsorption capacity of 2.3 mg/g CB. Since TTIP-EtOH carbon block and TiBu-EtOH carbon block have pCBA adsorption capacities of 2.4 and 2.2 mg/g CB, respectively, this result suggests that THO does not adversely influence the removal of pCBA and the breakthrough remains almost the same as before impregnation. The TTIP-EtOH impregnation coats only portions of the carbon block surface, leaving carbon surfaces and open pores available for organic contaminant adsorption. The Freundlich isotherm obtained from the batch experiments (not shown) for adsorptive removal of pCBA with powdered TTIP-EtOH and TiBu-EtOH through batch experiments also exhibited unfavorable adsorption of pCBA with the prepared THO—with the sorption constant 1/n values above 1 and small values of the Freundlich adsorption capacity K_{F}. These results confirm that adsorption of pCBA is mainly done by the uncovered surface of carbon block. The pCBA removal by THO-impregnated carbon block is not affected significantly by the background water chemistry, suggesting that removal of pCBA mainly occurs by unmodified carbon block surfaces and not by the added THO. These results indicate that THO-impregnated carbon block can achieve the dual purpose of simultaneously removing oxo-anions/metals and organic contaminants from water.

Titanium (IV) oxysulfate (≥29% Ti [as TiO₂] basis), titanium (IV) isopropoxide (TTIP) (97%) and titanium (IV) butoxide (TiBu) (reagent grade, 97%), pure ethyl alcohol (EtOH) (190 proof, ACS Spectrophotometric grade, 95%), and 4-chlorobenzoic acid (pCBA) (99%) were purchased from Sigma Aldrich. Acetic acid (Glacial, Certified ACS Plus) and hydrochloric acid (Optima Grade) were purchased from Fisher Chemicals. Sodium bicarbonate (ACS Grade) was supplied from AMRESCO and sodium arsenate (J. T. Baker, Dibasic, 7-Hydrate, ACS reagent) was purchased from J. T. Baker. All the chemicals and reagents were used as received and without any further modification. Other types of titanium salts and organic precursors can be used along with different solvents and acidic catalysts.

To quantify titanium content inside unmodified and impregnated carbon block, samples were digested with a mixture of HNO₃ and H₂SO₄. X-ray Fluorescence (XRF) (Model XL3, Thermo Scientific) was a secondary method for determination of titanium content of impregnated solids. The crystallinity of the structures was analyzed by XRD (PANalytical Aeris). Amorphous content of solids was quantified using the degree of crystallinity method. The morphology and Ti elemental mapping of the THO-impregnated carbon block were investigated using SEM and EDX (Helios 5, ThermoFisher Scientific). To evaluate the textural properties of the unmodified and impregnated carbon block and assess the accessible adsorption sites, surface area and pore size distributions were determined using Brunauer-Emmett-Teller (BET) and Barrett-Joyner-Halenda (BJH) models, respectively, fitting on a Tristar II Plus instrument (Micromeritics, USA). A Fourier-transform infrared (FT-IR) spectrometer (Frontier, Perkin Elmer) was used for analyzing the surface functional groups of the carbon block before and after impregnation to evaluate any probable detrimental effect or evolution of any new functional groups as a consequence of the impregnation processes.

To investigate and compare the arsenate adsorption capacity and removal efficiency of unmodified carbon block and all the impregnated carbon block under dynamic regime, as used in the POU filters, continuous flow column tests were performed. A model water containing 1.3 μM (100 μg/L) arsenate was prepared using sodium arsenate. Because the intent of the dual-purpose adsorbent is to remove both inorganic and organic pollutants from tap water within a single engineered “canister”, removal of the probe organic pollutant (pCBA) with an initial concentration of 1.9 μM (300 μg/L) was measured. No buffer was used, but the pH of the solution did not vary during the experiment (pH=6.3±0.1; 22±1° C.).

Unmodified and impregnated carbon block were inserted into a brass holder that forced water flow through the carbon block. A QG-150 pump with a Q2 head was used to continuously flow the water and a pressure gauge was installed on the inlet side of the column to monitor the pressure while also serving as a pulse dampener. Before the experiments, the system was pre-washed continuously with deionized (DI) water for 8 hr to remove any residues of the side products and unreacted chemicals until getting a constant pH of 5.5-6. The flow rate was set to be 60 mL/min, giving a loading rate of 4.5 m³/m²·hr and an EBCT of 0.28 minutes. These loading rates and contact times are typical for carbon block.

The presence of background oxo-anions (silicates, vanadate, phosphates, etc.) is known to adversely influence arsenate removal by metal oxide adsorbents. Therefore, to test their net effects on the modified THO-carbon block dual-purpose adsorbents, solutions were prepared by spiking 100 μg/L arsenate and 300 μg/L pCBA to the local tap water and 10× diluted tap water (initial pH of 7.6 and 7.8 and alkalinity of 160 and 16 ppm as CaCO₃) with two different conductivity values of 1314 and 139 μS/cm, respectively. These background salts represent realistic ranges for drinking water, including levels above the USEPA secondary total dissolved solids level of 500 mg/L (˜780 μS/cm), which is common in the southwestern USA where arsenate occurs naturally in groundwaters.

POU systems generally operate intermittently and result in on-off cycles of operation. During “off” operational modes, arsenate can diffuse from the near surface of the carbon block deeper into the pores of the adsorbent which makes available binding sites on the outer surface of the carbon block adsorbent once an “on” cycle is initiated. Therefore, arsenate removal from the system effluent was compared for continuous versus intermittent-flow operational modes. During intermittent flow mode, the impregnated carbon block was exposed to water flow for 14 hr followed by 10 hr of off mode, representing the night-time when a POU system is not usually used. The test was performed for 18 cycles until reaching a complete breakthrough.

Arsenate and other metal concentrations were quantified using inductively coupled plasma mass spectrometer (ICP-MS; Perkin Elmer NexIon 1000) with a detection limit of 0.5 μg/L. Before the measurements, 4 mL of influent or effluent samples were digested using 1 mL of a 10% HNO₃ solution, resulting in a 2% HNO₃ concentration.

Concentrations of pCBA were quantified by a high-performance liquid chromatograph (HPLC) with a photodiode array (PDA) detector (Waters Alliance 2695/2996 series). Briefly, the detection was performed with Waters 5 mm LiChrosorbs RP18 (4.6 mm×100 mm) column that was connected to a Waters 5 mm LiChrosorbs RP18 guard column (4.6 mm×10 mm) at 234 nm wavelength after passing a 200 μL sample loop. The mobile phase eluent was a mixture of DI water and acetonitrile at a fixed volume ratio of 60:40 and a flow rate of 0.6 mL/min. The detection was done at 25° C. with sample volumes of 20 μL and the minimum detection limit (MDL) was 3 μg/L. Before the analysis, the samples were filtered using 0.45 μm Nylon filters.

Batch adsorption tests were performed on select samples. First, to compare arsenate adsorption capacity of THO powders held at different drying temperatures, batch experiments were performed with the adsorbent dose of 6 mg/L using 1 L polypropylene bottles filled with DI water containing 200 μg/L of arsenate and 600 μg/L (pH=6.3±0.1; 22±1° C.); similar mass concentration ratios (3 μg As/μg pCBA) were the same as dynamic flow tests. Higher concentrations in batch tests were used because of very high adsorption capacity of the synthesized THO powder and desire to detect >99% removal of arsenate. Second, to obtain the Freundlich isotherm parameters for use in PSDM fitting, the same batch reactors with identical concentrations and conditions were employed. THO powders (formed outside the carbon block during synthesis) were ground, sieved with a mesh size of 170 (<90 μm), and added into the bottles at varying doses, ranging from 0.5 to 6 mg/L. To confirm samples were representative of THO inside carbon block pores, a set of batch experiments was performed using the most amorphous THO-impregnated carbon block that was crushed after impregnation and added to the bottles at the doses varying from 3.5 to 40 mg/L.

Bottles were shaken for 9 days to reach pseudo-equilibrium at room temperature. Arsenate and/or pCBA concentrations remaining in solution (Cₑ) were fit using the Freundlich isotherm model (qₑ=KCₑ^{1/2}), where qₑ is the adsorption capacity at equilibrium (μg/mg Ti), Cₑ is the concentration of the arsenate in the liquid phase at equilibrium (μg/L), K is the Freundlich adsorption capacity parameter (μg/mg Ti)(L/μg)^{1/n}, and 1/n is the Freundlich adsorption intensity parameter (unitless).

A MATLAB® code for the PSDM was used to parameterize and simulate the arsenate removal performance of the most and least amorphous THO-impregnated carbon block to study the influence of amorphous content of the synthesized THO on the mass transport and diffusivity of the impregnated carbon block in arsenate removal. Diffusion coefficients were parameterized over the first 10,000 bed volumes (BV), and then used to simulate breakthrough performance from 10,000 to 70,000 BVs.

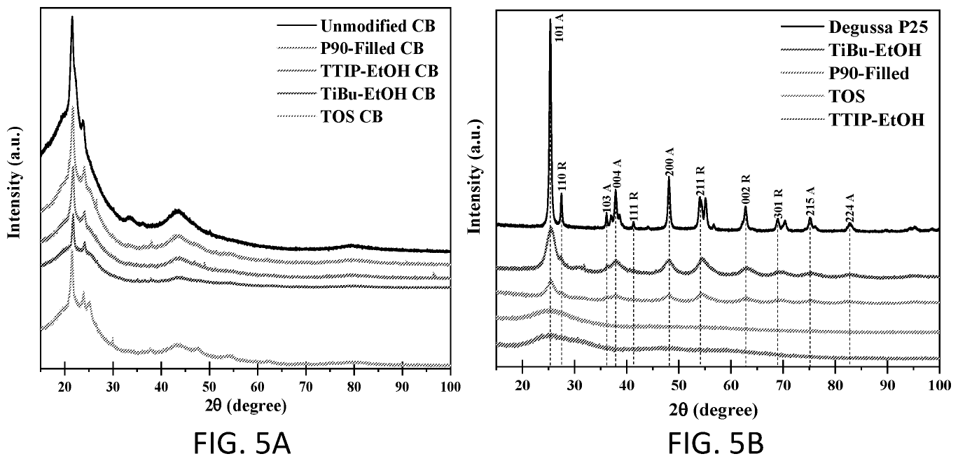

FIGS. 5A and 5B show XRD spectra of the unmodified and impregnated carbon block. The highest peaks detected in the XRD spectra of unmodified carbon block are observed at 23° and 43° that represent 002 and 100/101 facets of activated carbon, respectively, which are not decomposed after impregnation. Because X-rays do not penetrate very deeply into the impregnated carbon block, FIG. 5A shows only slight changes after impregnation. To enable characterization of the THO that forms inside the carbon block, FIG. 5B shows XRD spectra for THO powders produced ex-situ under the same temperature, pressure, and time conditions as the impregnated carbon block. Broad responses from 15° to 100° indicate a lack of crystalline TiO₂, for TTIP-EtOH and TOS samples. In contrast, TiBu-EtOH and P90-filled samples show sharper peaks, indicating more crystalline structures. As depicted in FIG. 5B, the most significant peak in TiBu-EtOH and P90-filled THO that occurs at 26° that belongs to the 101 plane of the anatase phase. 101 facets of crystalline TiO₂ are inefficient sites in adsorbing arsenate. FIG. 5B includes other detected peaks associated with the anatase and rutile phases of TiO₂. The results show that TTIP-EtOH has the highest amorphous content by 97%, which is followed by TOS (95%), P90-filled (64%), and TiBu-EtOH (58%).

The high amorphous content of TTIP-EtOH can be attributed at least in part to the incomplete hydrolysis and smaller formed nuclei that cannot proceed to further crystallization. Substitution of alkoxide groups of TTIP with carboxyl groups of acetic acid during the synthesis procedure results in partial hydrolysis and smaller nuclei. TTIP-EtOH as the most amorphous THO was studied further. The analysis shows that TTIP-EtOH sample dried at 60° C. holds a 97% amorphous content that is decreased to 68% for the sample dried at 450° C. The samples dried at 150° C., 250° C., and 350° C. also have an amorphous content of 91%, 80%, and 77%, respectively, that show increase of crystallinity with increasing drying temperature.

The most crystalline impregnated carbon block, produced via P90-filled and TiBu-EtOH synthesis, have lower Ti-loading of 8.6 wt % and 9.3 wt %, respectively. In contrast, amorphous TTIP-EtOH and TOS carbon block hold higher Ti-loading of 15.9 wt % and 12.2 wt %, respectively. This higher Ti-loading could be attributed to the stabilized TiO²⁺ ions due to the presence of acid in the synthesis procedure and well-controlled viscosity and reactivity of the precursor solution due to using acetic acid as the acidic catalyst. In some cases, mixing the titanium precursor with acetic acid in the first step of the synthesis leads to the replacement of the alkoxide groups with carboxylic groups that makes it a more controllable sol for binding and coating purposes. Amorphous metal oxides likely coat the surface of a media more homogeneously than the crystalline particles.

Inside the TOS carbon block amorphous THO exist as agglomerates and chains of THO particles. In contrast, inside the TTIP-EtOH carbon block amorphous THO more homogenously covers the surface, and potentially leads to more accessible arsenate adsorption sites. Inside TiBu-EtOH carbon block there are larger THO particles mostly in the crystalline form. Despite the existence of some tiny TiO₂ crystallites on the TTIP-EtOH carbon block surface, most of the particles are amorphous. This observation is consistent with the XRD spectra that no crystalline phase is detected in TTIP-EtOH, while some crystallinity occurs in TiBu-EtOH syntheses.

Individually formed THO nanoparticles are formed with diameters of 20 to 50 nm, which are an order of magnitude smaller in size than crystalline TiO₂ particles present in TiBu-EtOH carbon block. Smaller sized THO particles in TTIP-EtOH carbon block may result in higher surface areas and pore structures that facilitate intra-particle diffusion of arsenate. Based on EDX elemental mapping, all the sol-gel driven impregnated carbon block have an even distribution of THO particles on the surface, while THO distribution in TOS carbon block is more heterogeneous and agglomerated particles form. Adding commercial crystalline TiO₂ particles (Degussa P90) to the synthesis procedure of TiBu-EtOH increases the tendency to coating with crystalline TiO₂. Overall, all the sol-gel-based methods result in more homogenous surface coating with THO due to the in-situ condensation and polymerization step of the sol-gel technique.

Unmodified and impregnated carbon block are dominated by meso-pores (>2 nm and <50 nm), followed by micro-pores (≤2 nm), and <10% of the pore volume associated with macro-pores (≥50 nm up to 200 nm). TOS (0.072 cm³/g), TiBu-EtOH (0.081 cm³/g) or P90-Filled (0.077 cm³/g) carbon block have comparable total pore volumes that are roughly 35% lower than unmodified carbon block (0.119 cm³/g). TTIP-EtOH carbon block has the lowest total pore volume (0.051 cm³/g). Porosity distribution curves show that the impregnation procedures do not lead to the severe pore blockage in carbon block. Thus, there is little effect of impregnation on impinging water flow in ways that would impact pressure-loss through the entire carbon block.

Unmodified carbon block has a slightly higher surface area (571 m²/g) compared to 363 to 447 m²/g measured after impregnation. TTIP-EtOH synthesized carbon block has the lowest surface area (363 m²/g) among the impregnated samples, but the highest surface area (318 m²/g) among the ex-situ produced powders (e.g., TOS has 260 m²/g, TiBu-EtOH has 193 m²/g, P90-Filled has 171 m²/g). The higher surface area of the TTIP-EtOH is consistent with the smaller particles observed by SEM. Overall, the higher amorphous content based upon XRD and surface area for TTIP-EtOH synthesized materials supports the explanation that amorphous structures have a higher surface area and pore volume, which results in higher adsorption site density, relative to their corresponding crystalline species.

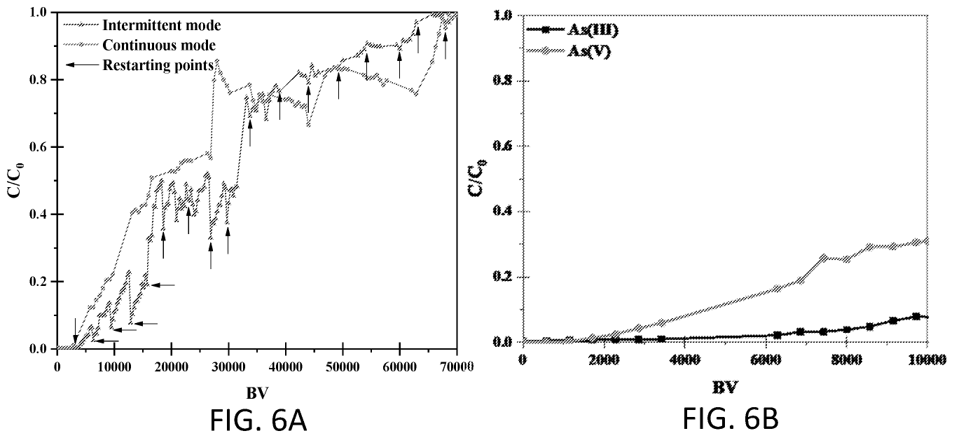

Because POU systems operate in cyclical on-off patterns, FIG. 6A shows resulting benefits for improved arsenate removal during cyclical operations with the best performing (TTIP-EtOH) carbon block, compared against continuous operation. Arrows in FIG. 6A indicate periods when flow through the system was intermittently turned off. Upon restarting the flow, 10-20% lower effluent arsenate concentrations occur. Without flow through the system (i.e., off-cycle, stagnation period) arsenate adsorbed near the outer surface of the impregnated carbon block have time to diffuse through pores or on the surfaces deeper into the adsorbents pores. At 40% arsenate breakthrough (C/C₀=0.4), TTIP-EtOH carbon block's arsenate adsorption capacity (2.3 mg As/g carbon block) during cyclical testing was 50% greater than during continuous flow (1.5 mg As/g carbon block), showing improved capability to remove arsenic from water. By later stages of arsenate breakthrough (e.g., C/C₀=0.8), the difference between the performance in two operation modes lessened, where the adsorption capacity of cyclical (3.3 mg As/g carbon block) operation was just slightly better than continuous operation (2.9 mg As/g carbon block). This occurs as the adsorbent approaches equilibrium with influent arsenate concentrations, resulting in a reduced driving force from water into the media due to saturated adsorption sites. During the early phase of the column operation and before reaching 10 μg/L (i.e., current arsenic MCL), the slope of the breakthrough curve for intermittent operation is more shallow than continuous operation, where the adsorption capacity is 67% higher with intermittent operation.

Arsenic can occur at two different oxidation states in water (arsenate (As(V)) or arsenite (As(III)). Arsenite is more difficult to remove than arsenate from water. FIG. 6B shows the capability of the TTIP-EtOH carbon block to remove either, and both, oxidation states of arsenic. This is attributed to the mixed oxidation states, as described below, of titanium and surface oxygen groups on the TTIP-EtOH carbon block.

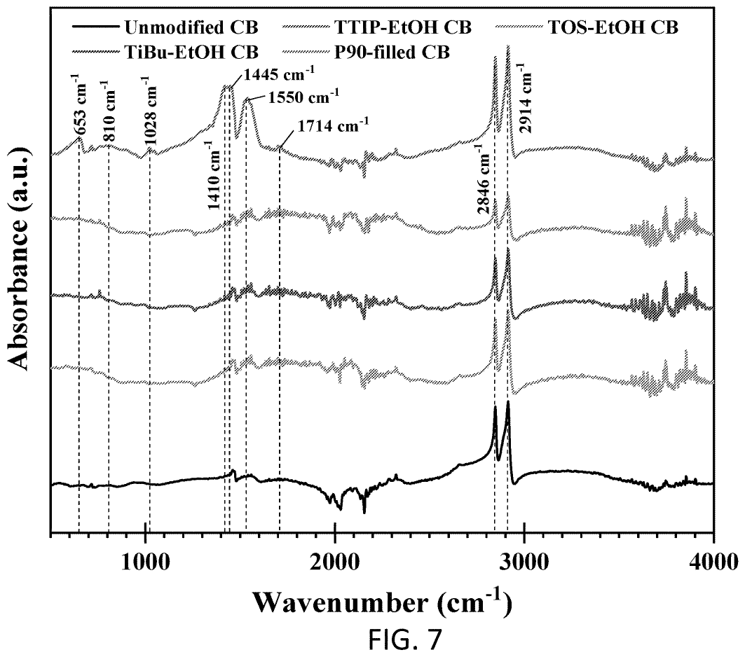

Organic functional groups on the synthesis precursor in a sol-gel approach result in incomplete hydrolysis and formation of amorphous phase rather than crystalline one. FT-IR spectra of amorphous TTIP-EtOH carbon block (FIG. 7) and comparison with unmodified carbon block indicates presence of more organic groups as a result of impregnation. The weak peak detected at 1714 cm⁻¹ in the TTIP-EtOH carbon block spectra is related to the C—O stretch and could be ascribed to the carboxylic groups that surrogate during the sol-gel procedure. An intensified peak at 1410 cm⁻¹ detected on TTIP-EtOH carbon block could be assigned to the vibration of O—H hydroxyl groups. The small peak observed in the spectra of TTIP-EtOH carbon block at 1028 cm⁻¹ belongs to the C—O stretching. Simultaneous occurrence of C═O, C—O, and O—H groups on the surface of TTIP-EtOH carbon block confirms the presence of carboxylic groups on the surface after impregnation, which is due to the carboxylation of the titanium precursor during synthesis and exchange of the alkoxide groups of TTIP with carboxyl groups in contact with acetic acid. Presence of these carboxyl groups is evidence of the modification of the titanium precursor with organic groups that replace the alkoxide group of TTIP. These organic groups are retained during the synthesis process, which could be a factor for incomplete hydrolysis that leads to the formation and precipitation of amorphous phase. Slow hydrolysis of TTIP results in retained organic groups on the surface that hold oxygen content. This increased oxygen content along with the randomness of the amorphous phase may lead to the presence of more adsorption sites and higher adsorption by TTIP-EtOH.

Presence of the observed carboxyl groups in TTIP-EtOH carbon block is evidence for the increased content of oxygen and hydroxyl groups after impregnation. This is likely beneficial for favorable arsenate adsorption, because the primary mechanism for arsenate removal is inner-sphere complexation through oxygen bridging, and increased content of oxygen increases the adsorption sites and chance of adsorption. It suggests that functionalization with carboxylic group as an agent can facilitate obtaining a more amorphous adsorbent.

To simulate arsenate breakthrough in continuous flow experiments, the pseudo-equilibrium adsorption capacity that serves as the driving force for diffusion into pores and surfaces of the impregnated carbon block can be useful. Table 3 summarizes the fitted values of Freundlich isotherms for arsenate adsorption by the different adsorbent powders. Freundlich intensity parameters (1/n) of 0.23 and 0.25 were obtained for TTIP-EtOH and TiBu-EtOH, respectively, as the most and least amorphous chemically synthesized adsorbents. Favorable adsorption occurs for l/n values below unity and lower values of 1/n show more favorable energetics and effectiveness of the adsorbent in lower chemical potentials, making the adsorbent efficient for removal in lower concentrations. Favorable 1/n values for TTIP-EtOH and TiBu-EtOH could be attributed to the numerous binding sites available on the surface of both sol-gel-derived adsorbents. Since 1/n values are nearly equivalent, the adsorption capacity (K) values can be compared for both materials, where K of amorphous TTIP-EtOH (10.7 (μg/mg Ti)(L/μg)^{1/n}) is 57% higher than semi-crystalline TiBu-EtOH (6.8 (μg/mg Ti)(L/μg)^{1/n}). Separately from experiments with the powders, batch adsorption experiments using crushed TTIP-EtOH carbon block yielded a 1/n value of 0.25 and K values of 1.7 and 11.0 corresponding to the dose of the impregnated carbon block and normalization to Ti mass, respectively. Comparable 1/n and K values between powders and crushed carbon block show the validity of using THO precipitates to represent THO on carbon block for the batch experiments. The better performance of amorphous TTIP-EtOH over semi-crystalline TiBu-EtOH particulates in batch experiments is consistent with the higher arsenate removal capability of TTIP-EtOH carbon block versus TiBu-EtOH carbon block observed in dynamic column tests.

TABLE 3
Fitted parameters for THO materials for arsenate adsorption by
TTIP-EtOH and TiBu—EtOH from batch and continuous flow tests

| | Freundlich isotherm | | | | | |
|---|---|---|---|---|---|---|
| | parameters | | | PSDM parameters | | |
| | | K (μg/mg | | Dₛ | Dₚ | |
| | | Ti)(L/ | | (cm²/ | (cm²/ | |
| | 1/n | μg)^{1/n} | R² | s) | s) | Bi |
| TTIP-EtOH | 0.23 | 10.7 | 0.97 | 3.1E−12 | 3.2E−6 | 32.3 |
| TiBu—EtOH | 0.25 | 6.8 | 0.98 | 0.28E−12 | 1.5E−6 | 50.2 |

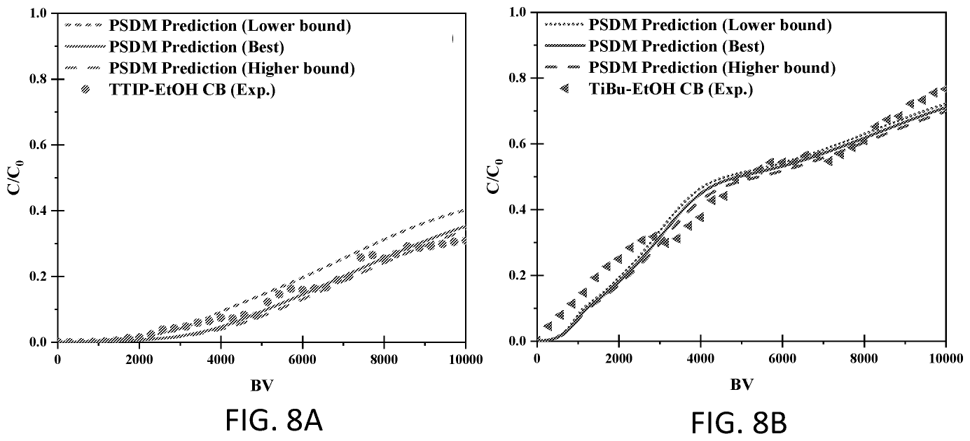

Using Freundlich isotherms obtained from batch experiments, FIGS. 8A and 8B show the pore surface diffusion model (PSDM) model fitting the experimental arsenate breakthrough curve. Upper and lower bounds on the PSDM parameterization are provided. Larger intraparticle mass transport limitations are observed within the TiBu-EtOH carbon block compared to the TTIP-EtOH carbon block when considering the fitted surface or pore diffusion coefficients (Dₛ or D_{P}) and associated combined Biot Numbers (Table 3). Dₛ and Dₚ values are ˜11 and ˜2 times higher for TTIP-EtOH carbon block compared to the TiBu-EtOH carbon block, respectively, which indicate greater intraparticle diffusion within the TTIP-EtOH carbon block. The amorphous nature of TTIP-EtOH likely results in higher diffusion coefficients due to smaller size of the particles and the presence of more accessible surface adsorption sites. Both datasets (Table 3) have Biot numbers >20, which suggests that intraparticle diffusion controls the overall mass transport of the system; higher values indicate greater importance of intraparticle mass transport. The combined higher equilibrium adsorption capacity (K) for TTIP-EtOH creates a large concentration-based driving force for arsenate in water into the modified carbon block, and lower net intraparticle diffusion mass transport limitations (i.e., lower Biot number for TTIP-EtOH carbon block).

In any POU device treating “real tap- or ground water”, the background matrix contains competing anions that co-occur with arsenate and affect its adsorptive removal along with trace organic pollutants. In particular, phosphate and silicate are the most competitive species—phosphate competes with arsenate to adsorb on the adsorption sites due to the almost similar charge and pKₐ values, and silicate polymerizes on the surface of metal (hydr)oxides to block the adsorption sites.

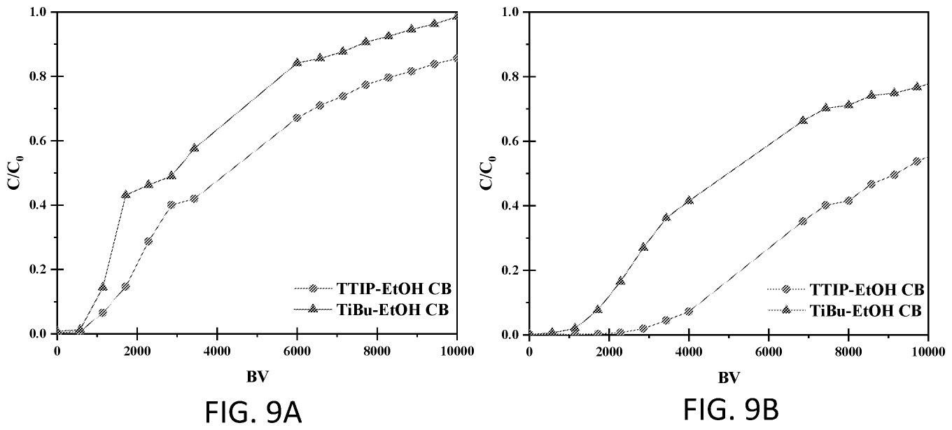

FIGS. 9A and 9B show arsenate breakthrough using TTIP-EtOH or TiBu-EtOH carbon block for local tap water (conductivity=1314 μS/cm) and 10× diluted tap water (conductivity=139 μS/cm) matrices spiked with the same arsenate levels. There was less efficient arsenate removal in the tap water with higher salts and background competing ions. TTIP-EtOH carbon block still performed better than TiBu-EtOH carbon block (i.e., lower effluent arsenate concentrations for TTIP-EtOH carbon block) that shows superior performance of amorphous THO compared to semi-crystalline one regardless of the background salts concentration. Table 2 summarizes arsenate adsorption capacities after treating 10,000 BV for these tests. Arsenate adsorption capacity from 10× diluted tap water matrix was ˜25% lower than removal from DI water experiments at conductivity of 2.6 μS/cm. Also, TTIP-EtOH and TiBu-EtOH carbon block removed arsenate from the non-diluted local tap water with ˜30% lower arsenate adsorption capacity compared against 10× diluted tap water.

Shapes of the arsenate breakthrough curve (FIGS. 9A and 9B) become steeper in the presence of higher background salts, which shows instantaneous competition between arsenate and other co-occurring competing anions for adsorption onto THO at higher concentrations of competing anions. Based on the water chemistry of the used tap water phosphate concentration is 6 μg/L as P that is very low compared to arsenate and unlikely to compete for adsorption with arsenate spiked at a 6× higher molar ratio (i.e., 7 μmole As/μmole P). So, dissolved silicate is most likely to be the dominant competing anion during arsenate adsorption by metal (hydr)oxides. The silica concentrations are 3.7 and 0.39 mg-Si/L in the tap water and 10× diluted tap water, respectively; this corresponds to 85 and 8.6 μmole Si/μmole As, respectively. Silica concentrations above >1 mg-Si/L can significantly affect arsenate removal. While silicate polymers and oligomers have a strong affinity to the THO surface, its corresponding monomers and dimers are not serious inhibitors for arsenate adsorption since arsenate has higher surface affinity and can repel the monomers and dimers. Less polymerization likely occurs at lower silicate concentrations, and therefore arsenate removal efficiency is less affected with lower silicate concentrations. Also, pH of the tap water matrices (7.8 for local tap water and 7.6 for 10× diluted tap water) is higher than the DI water matrix (pH=6.3). This higher pH affects the speciation of arsenate in water so that it occurs mainly in the form of HAsO₄²⁻ rather than AsO₄⁻ based on the pKₐ values of arsenate (pKₐ₁=2.3 and pKₐ₂=6.9). Also, pH_{PZC} of TTIP-EtOH and TiBu-EtOH carbon block were measured to be 4.5 and 5.1, respectively, and higher pH values result in increased negative charge of the THO surface. Increased negative charge of the adsorbent's surface along with the speciation of arsenate at higher pH leads to more electrostatic repulsion between the adsorbent and adsorbate that adversely affects the adsorption. Overall, the decline in the THO performance in the tap water matrix is likely attributable to the higher pH and oligomerization and polymerization of silicate on the metal (hydr)oxide surface, which occupies the adsorption sites and inhibits the arsenate adsorption.

Additional batch experiments with pCBA were performed using THO powders to confirm minimal adsorption capacity by the THO itself and predominant responsibility of activated carbon for pCBA removal. The batch experimental data and linearized Freundlich isotherm obtained for adsorptive removal of pCBA with powdered TTIP-EtOH and TiBu-EtOH exhibit unfavorable adsorption of pCBA, with the synthesized THO—1/n values above 1 and small values of K. pCBA removal by THO-carbon block is not affected significantly by the background water chemistry and occurrence of salts, which indicates that removal of pCBA mainly occurs by unmodified carbon block surfaces and not by the added THO-because silicate in tap water polymerizes on the THO surface and not the carbon surface. Overall, these results support the ability to fabricate modified carbon block to achieve the dual purpose of simultaneously removing oxo-anion and organic contaminants from water without impairing the characteristics of the carbon block.

### Example 2

A commercial activated carbon block (10″×2.5″, 5 μm) was procured from iSpring (Cumming, GA, USA). The as-received carbon block was bored into cylindrical coupons (32 mm diameter, 22 mm height) to facilitate bench-scale column tests. Two different types of CTHO materials were synthesized: 1) in-situ CTHO within activated carbon block to mimic the POU application, and 2) ex-situ CTHO material. Mixed CTHO was synthesized using a cerium alkoxide, a cerium salt, or commercial crystalline CeO₂ added to titanium isopropoxide (TTIP), as the titanium precursor, via sol-gel techniques. The hydrolysis rates and acidity of cerium alkoxides and salts affect the growth rate and crystallinity of CTHO particles.

Three different sol-gel synthesis approaches were used. TTIP-EtOH, as the reference THO material, was synthesized with TTIP, acetic acid, and EtOH. Cerium (IV) isopropoxide, cerium (IV) nitrate, or commercial CeO₂ were added to the synthesis as the cerium precursors to produce Ceₐₗₖ TIP, Ceₛₐₗₜ TIP, and CeₒₓTIP, respectively. The carbon block coupons were impregnated with the synthesis solutions. An annealed form of Ceₐₗₖ TIP (A-Ceₐₗₖ TIP) was produced only ex-situ because the carbon block deforms at 550° C.

Ex-situ THO and CTHO synthesized materials, produced without carbon block material, were ground and sieved to a particle size of <170 mesh (<90 μm) and used in batch screening experiments and some material characterization measurements. Batch experiments were conducted in a model water using >18 Mohm ultrapure water (Nanopure) with equal molar concentrations of arsenate, selenate, vanadate, tungstate, and chromate (1.35 μM) at an initial pH of 6.3±0.2 and a temperature of 23±1° C. Preliminary kinetic tests with continuous shaking (200 rpm; 1 liter polypropylene bottles)) using an adsorbent dose of 30 mg/L revealed that 7 days was sufficient to reach a pseudo equilibrium oxo-anion concentration. Subsequent equilibrium batch experiments were conducted with adsorbent doses ranging from 5 to 30 mg/L and equal oxo-anion concentrations (13.5 μM). Equilibrium adsorption data were fit to a Freundlich isotherm model (q_{c}=KCₑ^{1/n}), where qₑ is the adsorption capacity at equilibrium normalized to the metal content of the adsorbent (μmole oxo-anion/mole (Ti+Ce)), Cₑ is the oxo-anion liquid-phase concentration at equilibrium (μM), K is the Freundlich adsorption capacity parameter (μmole oxo-anion/mmole adsorbent)(μM)^{1/n}, and 1/n is the Freundlich adsorption intensity parameter (unitless).

Continuous flow experiments were performed in model and tap waters through non-modified (as-received) or in-situ impregnated carbon blocks. Waters with equal molar concentrations of arsenate, selenate, vanadate, tungstate, and chromate (1.35 μM) were pumped (60 mL/min) upward through the carbon block at a loading rate of 4.5 m³/m²·hr and an empty bed contact time (EBCT) of 17 seconds, typical for carbon block POU filters. The pressure drop across all experiments was negligible (<3 psi). To represent a “real” water matrix, tap water (Tempe, Arizona, USA) with a pH of 7.9=0.1 was spiked with equal molar concentrations of the individual oxo-anions (1.35 μM) and treated using the CTHO carbon blocks. All batch and continuous flow experiments were performed at room temperature (23±1° C.).

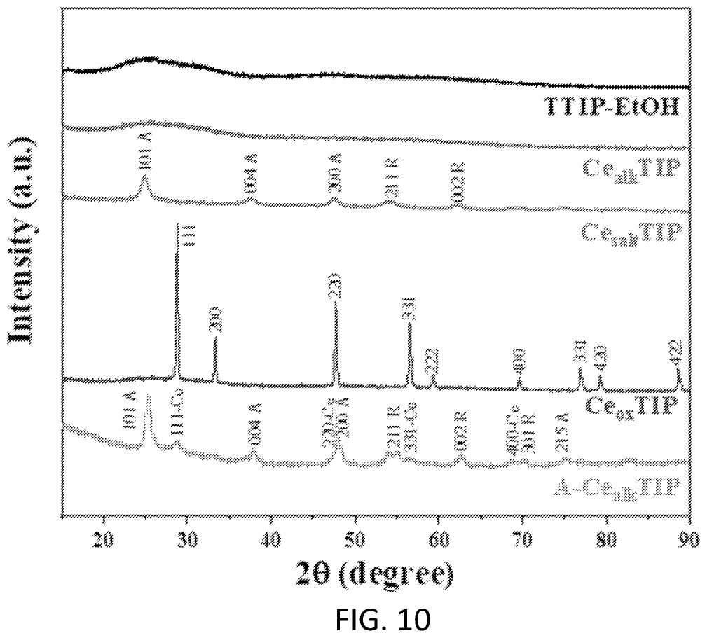

Ex-situ synthesized CTHO materials without the carbon block were initially performed to gain mechanistic insights on oxo-anions removal by CTHOs and optimize the ratios for subsequent work using in-situ CTHO with carbon block. XRD spectra of the THO sample shown in FIG. 10 indicate that the TTIP-EtOH synthesized material has an amorphous structure before the addition of Ce. Upon adding cerium, the synthesized CTHO materials exhibit different levels of crystallinity. Analysis reveals that Ceₐₗₖ TIP material contains over 98% amorphous CTHO with no detectable crystalline peaks.

The XRD spectra of Ceₛₐₗₜ TIP material exhibit a few weak crystalline peaks associated with the anatase and rutile phases of TiO₂. However, no crystalline peaks related to ceria were observed, suggesting that the structure of Ceₛₐₗₜ TIP includes partially crystallized THO and amorphous CHO. In contrast, the CeₒₓTIP material displays crystalline peaks attributed to CeO₂, while no crystalline peak is detected for titanium, indicating that the introduction of crystalline CeO₂ did not impact the amorphous structure of THO. The A-Ceₐₗₖ TIP sample reveals crystalline phases of both titania and ceria due to thermal treatment and crystallization of the amorphous phases of ceria and titania. Overall, four distinct CTHO materials were created, each characterized by different combinations of titania and ceria crystallinity, achieved through the utilization of various Ce precursors and synthesis conditions.

Table 4 summarizes elemental composition of CTHO samples. CeₐₗₖTIP, which was the least crystalline material, has the lowest Ti+Ce content. An oxygen-to-metal molar ratio for amorphous CeₐₗₖTIP is 3.51, which decreases in other samples following the crystallization of at least one metal component.

TABLE 4
Elemental composition of the synthesized ex-situ CTHOs, and Ti and Ce loading of CTHO-impregnated
carbon blocks - Data obtained based upon samples digestion and CHNS/O analyses

| | | | | | | | | BET | Total pore |
|---|---|---|---|---|---|---|---|---|---|
| | | Wt % | | | | | | surface | volume |
| Synthesized material | | Ti | Ce | C | N | H | O | area (m²/g) | (cm³/g) |
| Ex-situ | TTIP-EtOH | 51.2 | 0 | 17.4 | 0 | 2.3 | 29.1 | 318 | 0.024 |
| powder | Ceₛₐₗₜ TIP | 41.1 | 8.4 | 6.1 | 3.1 | 1.4 | 39.9 | 341 | 0.037 |
| | Ceₐₗₖ TIP | 32.8 | 6.3 | 17.3 | 0 | 2.9 | 40.7 | 368 | 0.045 |
| | Ceₒₓ TIP | 44.3 | 1.3 | 18.9 | 0 | 2.1 | 33.4 | 302 | 0.021 |
| | Annealed Ceₐₗₖ TIP | 51.7 | 11.5 | 0.9 | 0 | 1.3 | 34.6 | 127 | 0.009 |
| In-situ to | TTIP-EtOH carbon block | 15.9 | 0 | NA* | NA* | NA* | NA* | 363 | 0.051 |
| carbon | Ceₛₐₗₜ TIP carbon block | 12.2 | 2.5 | NA* | NA* | NA* | NA* | 227 | 0.032 |
| block | Ceₐₗₖ TIP carbon block | 12.8 | 2.7 | NA* | NA* | NA* | NA* | 365 | 0.046 |
| | Ceₒₓ TIP carbon block | 13.2 | 0.8 | NA* | NA* | NA* | NA* | 376 | 0.047 |
| | Unmodified carbon block | 0.9 | 0 | NA* | NA* | NA* | NA* | 571 | 0.119 |

*C, N, H, and O are not measured for the impregnated carbon blocks due to the presence of the elements on the carbon block itself.

According to the surface areas summarized in Table 4, the amorphous CeₐₗₖTIP material displays the highest surface area (368 m²/g) among the ex-situ synthesized CTHO materials. However, after annealing and crystallization of both titania and ceria, the surface area decreases to 127 m²/g. This reduction in surface area is consistent with the higher amorphous content of CeₐₗₖTIP, as increased crystallinity typically leads to a decrease in surface area. The higher surface area of CeₐₗₖTIP compared to other ex-situ CTHO materials can enhance its adsorption capacity by providing more active surface sites for adsorption.

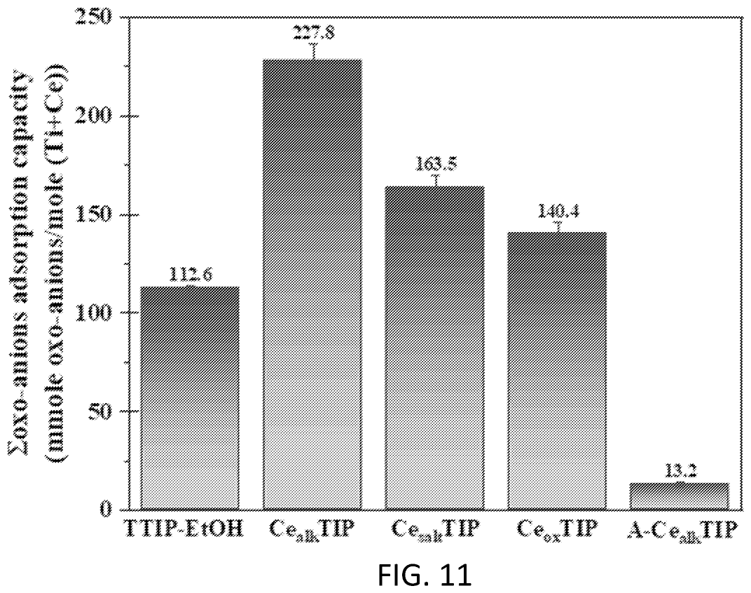

Mechanistic evaluation of influences of different ex-situ synthesized CTHO materials on simultaneous adsorptive removal of oxo-anions from water was carried out through batch pseudo-equilibrium adsorption experiments. FIG. 11 shows the adsorption capacity for total oxo-anion concentration obtained from pseudo-equilibrium batch experiments, comparing various ex-situ synthesized CTHOs and TTIP-EtOH (mmol oxo-anions/mole (Ti+Ce)). With the exception of A-CeₐₗₖTIP, which possesses both crystalline structures of THO and CHO, the addition of Ce in any form to the reference THO material resulted in increased adsorption capacity. TTIP-EtOH exhibited an adsorption capacity of 113 mmol oxo-anion/mol (Ti+Ce), while CeₐₗₖTIP, featuring amorphous structures of both THO and CHO, displayed the highest adsorption capacity (228 mmol oxo-anion/mol (Ti+Ce)) among the CTHOs. Notably, CeₐₗₖTIP exhibited double the capacity compared to TTIP-EtOH.

For each adsorption experiment the data were fit by Freundlich isotherms. The value of 1/n for all oxo-anions using CeₐₗₖTIP is lower than that for CeₛₐₗₜTIP, CeₒₓTIP, and A-CeₐₗₖTIP. This suggests that oxo-anions are more thermodynamically favorable adsorbed by totally amorphous CeₐₗₖTIP. Higher values of K_{F} for all oxo-anions removed by CeₐₗₖTIP compared to other CTHOs are also consistent with the achieved highest adsorption capacity of amorphous CeₐₗₖTIP, as shown in FIG. 11.

Favorable adsorption was observed for arsenic, vanadium and tungsten based upon their isotherms have 1/n values below unity. The lowest 1/n values were obtained for V(V), followed by W(VI), As(V), Cr(VI), and Se(VI), indicating that vanadate had the most favorable adsorption onto CTHOs. Differences in oxo-anion adsorption affinities can be attributed at least in part to their speciation in water at the test water pH of 6.3 and the unique electronic structure of each oxo-anion. Approximately 92% of vanadate and 75% of arsenate exist as monocharged anions at pH=6.3. Chromate is present in equal amounts of HCrO₄⁻ and CrO₄²⁻ species, while 96% of tungstate and 100% of selenate are present as WO₄²⁻ and SeO₄²⁻, respectively. Since the pH_{PZC} of CTHOs was 5.7 to 6.6, at the experimental pH of 6.3, both protonated and deprotonated surface sites are available to complex with the oxo-anions. At pH 6.3, the electrostatic repulsion between the fully deprotonated oxo-anions and the adsorbent surface becomes more pronounced, particularly for species including WO₄²⁻ and SeO₄²⁻. Consequently, these oxo-anions are expected to have less favorable binding affinity (indicated by higher 1/n values) and lower adsorption capacity (K_{F}). However, this is not the case for tungstate, while it holds true for diprotic selenate. This implies that factors such as surface potential and degree of deprotonation alone cannot completely predict the observed selectivity of adsorption.

Several ion-specific chemical properties may explain differences in adsorption selectivity. Tungstate is more hydrated (37 cm³/mol) than selenate (32 cm³/mol), which results in a lower charge density (i.e., charge-to-surface area ratio). Tungstate's lower negative charge density results in less electrostatic repulsion interactions with the adsorbent surface, making it easier to bind. Additionally, while selenate can only bind to the surface through oxygen bridging, tungstate can polymerize on the metal (hydr)oxide surface in the presence of water molecules. Because amorphous adsorbents contain a high content of trapped water, tungstate polymerization is facilitated, potentially leading to a higher adsorption capacity than selenate.

The adsorption site density of the unannealed CTHO materials ranges from 0.0049 to 0.0052 mmole/m², with amorphous CeₐₗₖTIP having approximately 20% higher density than the reference THO. This suggests that CTHO materials are more effective at binding oxo-anions than THO materials, which could be attributed to the higher oxygen content of the CTHO materials. However, the trend of the materials' oxygen content density is different, which shows that solely the oxygen content of the material cannot predict the adsorption capacity, although adding cerium increases the oxygen content. At least three reasons justify this finding. First, the oxygen content of the material includes trapped water, lattice oxygen, surface oxygen, and retained carboxyl groups. Most of the oxygen content is due to the lattice oxygen that does not contribute to adsorption. For crystallized A-CeₐₗₖTIP, oxygen content density is the highest as opposed to its oxo-anions adsorption density, which shows an increased ratio of lattice oxygen content by increasing the degree of crystallinity. The second reason is the disorders in amorphous materials that result in the availability of more surface oxygen content that adsorbs oxo-anions. Furthermore, the greater randomness in amorphous adsorbents results in spatial constraints in the binding that may lead to monodentate binding rather than bidentate binding, resulting in more available adsorption sites. Finally, besides surface oxygen, oxygen vacancies in amorphous adsorbents participate in arsenic adsorption as essential sites. However, the type of oxygen content in the adsorbent depends on the crystallinity and is not typically a single reliable indicator of higher adsorption capacity.

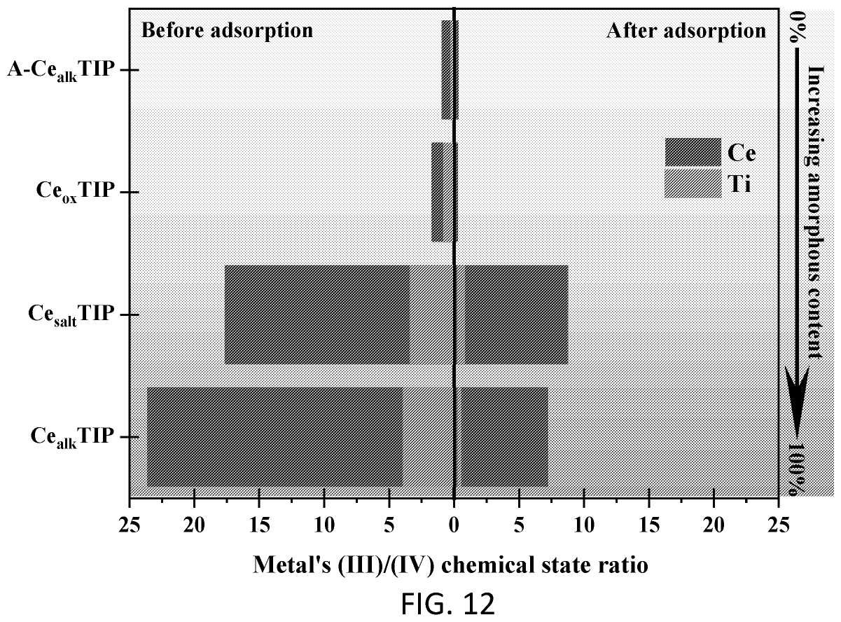

XPS analysis of ex-situ samples, both before and after arsenate adsorption, provided valuable insights into the role of ceria and titania oxidation states. The presence of a higher fraction of metals in a reduced oxidation state corresponds to an increased number of oxygen vacancies in the metal (hydr)oxides. Titania and ceria can exist in two oxidation states (e.g. III and IV), and ratios of (III)/(IV) oxidation states differs for each metal differs among each synthesis technique. FIG. 12 presents the cumulative and individual ratios of Ti(III)/Ti(IV) and Ce(III)/Ce(IV) in various ex-situ synthesized CTHO materials before and after oxo-anion adsorption.

CeₐₗₖTIP exhibits the highest ratios of Ti(III)/Ti(IV) and Ce(III)/Ce(IV), with values of 3.76 and 19.8, respectively. Increasing the crystallinity of the samples leads to lower (III)/(IV) ratios. After arsenate adsorption, for both ceria or titania the (III)/(IV) ratios decrease significantly, indicating the active participation of the (III) oxidation state of the metals in the adsorption process rather than the (IV) state. Notably, although the Ti(III)/Ti(IV) ratio is above unity, the Ce(III)/Ce(IV) ratio is higher, emphasizing the positive effect of Ce incorporation by providing more reduced state metal and additional adsorption sites on the adsorbent.

The positive trend emerged between the (III)/(IV) ratio and the amorphous content of the material and suggests a higher oxygen vacancy content in amorphous CTHO due at least in part to its disordered structure, resulting in a higher adsorption capacity for oxo-anions, as observed in FIG. 11. In samples containing amorphous ceria, the (III) states are more abundant, influencing the adsorptive removal process. The presence of both Ti and Ce in two oxidation states highlights the redox ability of the adsorbent, which could be beneficial for adsorbing various oxo-anion species, such as mixtures of arsenite and arsenate.

Besides the oxygen vacancies effect, indicated by metals oxidation states discussed above, the O1s region of the XPS shows that the Ti/Ce—OH peak ratios of the virgin adsorbents decreased after arsenate adsorption (e.g., from 43% to 36% for CeₐₗₖTIP). This is followed by a shift of the bridging oxygen peak to a higher binding energy and an increase in its relative ratio, indicating the formation of an oxygen bridge between the oxo-anions and the adsorbent surface due to inner-sphere complexation. The spectra for both C1s and O1s regions reveal the presence of C═O binding on the surface of amorphous CeₐₗₖTIP before adsorption, as evidenced by the C═O peak. However, after adsorption, the ratio of the C═O peak decreased by 15% in the C1s spectrum and 1.5% in the O1s spectrum, indicating that carboxyl groups also served as adsorption sites for oxo-anions through oxygen bridging. The increase in the C—O/C═O ratio from 0.84 to 2.5 in the C1s spectra after adsorption supports this finding.

To validate the structural similarity between in-situ and ex-situ synthesized CTHO materials, characterization was conducted on the impregnated carbon blocks derived from three different synthesis techniques (CeₐₗₖTIP, CeₛₐₗₜTIP, and CeₒₓTIP). However, A-CeₐₗₖTIP could not used for impregnation due to the carbon block's decomposition at 550° C., emphasizing the importance of impregnation with amorphous metal (hydr)oxides at lower temperatures instead of using crystalline counterparts at elevated temperatures.

All three ex-situ synthesis techniques achieved Ti content of 12 to 16 wt % in the carbon blocks (Table 4). The inclusion of cerium during synthesis led to a cerium content of 0.8 to 2.7 wt % within the carbon block, with CeₐₗₖTIP exhibiting the highest content. However, considering the results presented in Table 4 and FIG. 11, it appears that higher metal loading is not a prerequisite criterion for impregnating a porous media; instead, the nature of the impregnating metal also plays a role. The Ce to Ti ratio in the CTHO-impregnated carbon block closely matches the ratio observed in the corresponding ex-situ samples, with a difference of <3%. The BET surface areas of the CTHO-impregnated carbon blocks ranged from 227 to 376 m²/g, which is lower than that of the as-received carbon block (571 m²/g). This decrease indicates some pore blockage caused by CTHO particles or films on the activated carbon. Among the synthesis techniques, CeₛₐₗₜTIP resulted in the lowest surface area (227 m²/g), while CeₐₗₖTIP and CeₒₓTIP exhibited similar values (365 to 376 m²/g).

The SEM images of the cross-sections of CTHO-impregnated carbon blocks revealed that smaller particles (50 to 200 nm in size) were produced using amorphous CeₐₗₖTIP, compared to the larger particles (200 to 800 nm) produced during CeₛₐₗₜTIP and CeₒₓTIP synthesis techniques. EDX elemental mapping on the cross-sections of CTHO-impregnated carbon blocks indicated an even distribution of CTHO particles, suggesting a homogeneous surface coating within the carbon block pores. Spatially within the carbon block, Ti and Ce elements were co-located along with a high oxygen level, indicating bridging between THO and CHO and forming their (hydr)oxides rather than pure metallic form. Overall, the CeₐₗₖTIP achieved the highest Ce content, even distributed Ce and Ti within the activated carbon pores, and among the highest surface areas of the three impregnation schemes.

Because concentration gradients of oxo-anions in bulk versus surface or intraparticle pores also influence mass transfer (i.e., Fick's Law), continuous flow experiments were performed at environmentally relevant oxo-anion concentrations. There was no removal of oxo-anions by non-modified carbon block (not shown). In the breakthrough curves of oxo-anions from a mixture in model water treated using in-situ synthesized CTHO carbon block, selenate was least efficiently removed, whereas vanadate was the most efficiently removed. The order of removal of the oxo-anions varied based upon the impregnation method. Oxo-anions with the lowest Freundlich 1/n values from the batch experiments were likewise those removed most efficiently in continuous flow tests. An exception was tungstate, which has a lower 1/n and higher K_{F} than arsenate in batch-experiments but less efficient removal in continuous flow experiments. This behavior could be attributed to the mass transport kinetics of the oxo-anions within the porous adsorbent material. Oxo-anions must diffuse through a stagnant film and the pores to reach the adsorption sites. The larger hydrated volume of tungstate than arsenate may lead to lower pore diffusivities within the impregnated carbon block. Batch experiments were performed at equilibrium (i.e., 7 days) where mass transfer kinetics play a negligible role in comparison to significant effects mass transfer within the modified carbon block in continuous flow experiments (i.e., 17 second EBCT).

Adding cerium to the THO-impregnated carbon block enhanced the removal of all oxo-anions except selenate. The results of the continuous flow experiments are consistent with those of the batch experiments, showing that the CTHO-impregnated carbon blocks have higher (>35%) cumulative oxo-anion adsorption capacities after treating 10,000 BV of water containing a mixture of oxo-anions than the THO impregnated carbon blocks without cerium integration. CeₐₗₖTIP-impregnated carbon block has the highest removal capacity to simultaneously remove multiple oxo-anions, with a total oxo-anion removal capacity of 24.5 mmole oxo-anion/mole (Ti+Ce) at 10,000 BV.

Cumulative oxo-anion removal in continuous flow experiments is lower than removal in batch experiments. However, this disparity arises at least in part from evaluating the performance of the impregnated carbon block after treating only 10,000 BV. As evidenced by the breakthrough profiles, many oxo-anions have only partially broken through, indicating that the impregnated carbon block is far from reaching saturation. To achieve higher adsorption capacities, a potential design solution is to install two impregnated carbon blocks in series, adopting a lead-lag configuration.

Experiments using oxo-anion spiked tap water with a pH of 7.3 and containing various ions instead of ultrapure water showed less efficient oxo-anion removal, highlighting the significance of water matrices. After treating 10,000 BV of spiked tap water, the adsorption capacity was 53% lower for the CeₐₗₖTIP carbon block and 60% lower for the TTIP-EtOH carbon block, which did not have Ce added. An added benefit of CTHO-impregnated carbon block was inadvertently observed because the tap water also contained copper, leached from building plumbing. The CeₐₗₖTIP carbon block removed Cu from the tap water. However, overall, similar to the observed performance in model water, the amorphous CeₐₗₖTIP carbon block exhibited the highest capacity (11 mmol oxo-anions/mole (Ti+Ce)) among the CTHO-impregnated carbon blocks in the spiked tap water experiments. Moreover, all CTHO-modified carbon blocks demonstrated higher capacity compared to the TTIP-EtOH carbon block, indicating the positive impact of Ce addition to THO, even in tap water.

The addition of cerium to THO and impregnating the mixed-metal (hydr)oxide into a carbon block filter enables a POU filter to simultaneously remove mixtures of oxo-anions, including arsenate, vanadate, tungstate, chromate, and selenate, as well as cationic heavy metals such as Cu.

The CTHO-impregnated carbon block with the highest surface area, spatial disorder, and oxygen vacancy exhibited the most effective oxo-anion removal. Oxygen content of the amorphous adsorbent alone does not solely determine oxo-anion adsorption. The oxidation state of the metal attached to the oxygen (i.e., central metal) also plays a role. The amorphous composition of the mixed-metal oxide directly impacts the content of the metals' reduced form, which is (III) for Ti and Ce, consequently influencing the adsorption capacity. The presence of both Ce and Ti in oxidation states III and IV, along with the modulation between these states before and after adsorbing oxo-anions, suggests that amorphous CTHO can facilitate redox reactions alongside adsorption. Example 3

Titanium (IV) isopropoxide (TTIP) with a purity of 97% and pure ethyl alcohol (EtOH) with a grade of 190 proof (ACS Spectrophotometric grade, 95%) were obtained from Sigma Aldrich. Glacial acetic acid (Certified ACS Plus) was purchased from Fisher Chemicals. Sodium bicarbonate (ACS grade) was supplied by AMRESCO, and sodium arsenate (J. T. Baker, Dibasic, 7-Hydrate, ACS reagent) was acquired from J. T. Baker. All the chemicals and reagents were used as received without any further modifications.

A low titanium-containing activated carbon block (10″×2.5″, 5 μm) with the product number FI-ES-CAB10 was procured from APEC (CA, USA). To determine the porosity of the carbon block, a small cylindrical piece (obtained by drilling a volume of 17 cm³) was submerged in hot water, and the displaced water was measured using a graduated cylinder. The carbon block has a thickness of 1.3 cm, an outer diameter of 6.3 cm, an inner diameter of 3.6 cm, and a height of 24 cm. This results in a total volume of 480 cm³ for the activated carbon block, with a void space of 244 cm³ in the center. Based on the measured porosity of 68%, the carbon block possesses a total pore volume of 330 cm³ (calculated as 480×0.68). Therefore, each carbon block module's net volume of the pores and void space is 574 cm³ (or 1,148 cm³ for two carbon blocks combined).

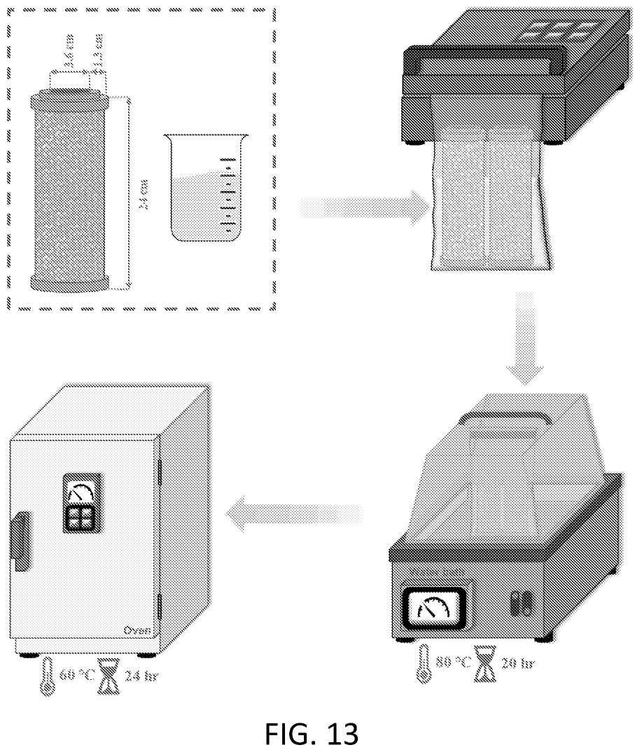

FIG. 13 illustrates the dimensions of the carbon block and the process of impregnating it with amorphous THO using a Sous vide technique. The impregnation was conducted using commercial vacuum bags (FoodSaver 11″ Heavy Duty rolls). The carbon blocks were not disassembled and were used as received, including the outer plastic mesh and rubber seal endcaps. Two carbon blocks were placed inside a single bag for simultaneous impregnation. Following sol-gel synthesis procedure, the ratios of the precursors and solvents were adjusted to achieve a total solution volume of 1,150 mL. Briefly, 340.7 mL of titanium isopropoxide (TTIP) and 387.8 mL of acetic acid were mixed and stirred for 75 minutes in a beaker. Subsequently, 421.5 mL of ethanol (EtOH) was added to the mixture. After stirring for 5 minutes, the solution was transferred to the vacuum bag containing the two carbon block modules. The vacuum bag containing the carbon blocks and the sol-gel synthesis solution was placed under the Sous vide machine (NESCO Deluxe model VS-12). The “Marinate” function intermittently applied vacuum, evacuating trapped air from the activated carbon block's pores and facilitating the solution's penetration. This function was repeated until no further bubbling was observed. If the sous vide machine does not have a “Marinate” function, the “Pulse” function can be an alternative for this step. Next, the “Vacuum and Seal” function was utilized to apply a higher-intensity vacuum, followed by immediate bag sealing. To ensure proper sealing, an additional manual double seal was used. The sealed and evacuated bag, containing the carbon blocks and the solution, was then placed in a preheated water bath at 80° C. The aging step was performed for 20 hours inside the water bath. Afterward, the vacuum bag was cut open, and the carbon blocks were removed and dried overnight at 60° C. Once dried, the carbon block was pre-washed with >18 Mohm nanopure (ThermoFisher, Barnstead GenPure) and inserted into a standard 12″×4″ housing for further washing with nanopure water at a continuous flow rate of 1 L/min for 30 minutes. The THO powders formed ex-situ to the carbon block were also collected, washed with EtOH and nanopure water, and dried at 60° C. overnight for further characterization tests.

The conventional autoclave synthesis was conducted using a small cylindrical piece of the carbon block (diameter of 3.1 cm and height of 2.3 cm) due to the larger size of the whole carbon block, which cannot fit inside a lab-scale autoclave. The objective was to compare the structure of the resulting THO between the two methods. For the autoclave method, a cylindrical coupon of the carbon block with a volume of 17 cm³ was obtained by cutting it using a drilling tool. Initially, 20.2 mL of TTIP was mixed with 23 mL of acetic acid and stirred for 75 minutes. Subsequently, 25 mL of EtOH was added to the solution. After stirring for 5 minutes, the carbon block piece was immersed in the solution, and a direct vacuum was applied to it using a vacuum pump. The solution and carbon block were then transferred to a Teflon-lined stainless-steel autoclave and aged in an oven at 80° C. for 20 hours. The impregnated carbon block was subsequently washed with ethanol and nanopure water and dried overnight at 60° C. The same washing and drying procedures were carried out on the THO formed ex-situ to the carbon block, and the resulting powders were utilized for further characterization.

For the POU treatment tests, the non-modified and THO-impregnated full-size carbon blocks were placed in separate POU continuous flow systems. A sediment filter was positioned before the carbon block module. Control tests confirmed that the sediment filter did not remove any arsenic. Water flowed through the carbon block module by gravity at a controlled flow rate of 1 L/min, regulated by a valve. The carbon block had an empty bed contact time (EBCT) of 28 seconds. The water passed through the system in daily cycles, consisting of 14 hours of continuous flow followed by 10 hours of stagnation with no flow, representing the intermittent water flow through a POU filter.

Two different water matrices containing arsenic were investigated. The first water matrix consisted of local tap water from Tempe, AZ, with a conductivity of 1,368 μS/cm and a pH of 7.9, spiked with 100 μg/L of arsenate. The same matrix was spiked with 10 μg/L of arsenate to evaluate the arsenic removal and risk reduction when exposed to concentrations as low as the MCL. The second water matrix was local groundwater, which served as a drinking water supply and had a conductivity of 1,132 μS/cm and a pH of 8.2. The groundwater contained 36 μg/L of arsenate (As(V)) and no arsenite (As(III)). The groundwater had been previously treated to bring the arsenic concentration below the MCL of 10 μg/L. All experiments were conducted at a temperature of 23±1° C. Throughout the experiments, influent and effluent water samples were collected regularly.

The crystallinity of the formed THO was examined using a powder X-ray diffractometer (XRD, PANalytical Aeris) to compare its structure with THO synthesized conventionally inside a Teflon-sealed autoclave. The titanium content of the impregnated carbon block was quantified through acid digestion of the samples, followed by analysis via an inductively coupled plasma mass spectrometer (ICP-MS, Perkin Elmer NexIon 1000). Briefly, the samples were digested using a mixture of H₂SO₄ and HNO₃, following the standard method 3030-G. The titanium concentration was then measured using an ICP-MS. X-ray fluorescence (XRF) analysis (XL3, Thermo Scientific) was employed as a secondary method to confirm the titanium content. To investigate the homogeneity of the titanium coating inside the carbon block, elemental mapping was conducted using scanning electron microscopy (SEM) coupled with energy-dispersive X-ray spectroscopy (EDX) on different parts of the carbon block (Helios 5, Thermo Fisher Scientific).

The metal concentration in the influent and effluent samples collected throughout the arsenic removal tests was quantified using ICP-MS. Before the analysis via ICP-MS, 4 mL of the samples were digested using 1 mL of a 10% HNO₃ solution, resulting in a final concentration of 2% HNO₃ in the digested samples.

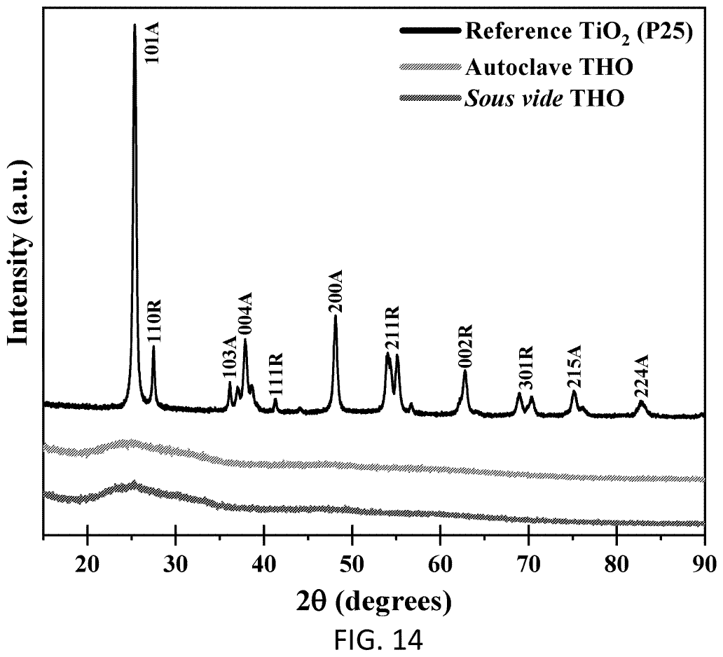

Material characterization confirms that the conditions of the Sous vide technique produce THO material that closely resembles those of the conventional autoclave synthesis approach. FIG. 14 presents the X-ray diffraction (XRD) spectra obtained from two samples: (1) THO powder that remained within the Sous vide vacuum bag but was formed outside the carbon block, and (2) THO powder produced using a conventional Teflon-lined autoclave. XRD analysis could not be performed on THO impregnated within the carbon block due to the formation of THO inside the pores of the porous carbon block and the relatively low titanium content compared to activated carbon. The XRD spectra of the two THO samples exhibit only a broad peak around 25°, which is indicative of amorphous titanium (hydr)oxide. FIG. 14 includes a reference XRD pattern for crystalline TiO₂ to highlight the differences from the THO samples. The XRD spectra of the THO samples produced by the Sous vide and conventional autoclave methods are nearly identical.

Exposure of the synthesis solution to water or moisture increases the hydrolysis rate, forming a more crystalline structure. No additional water was introduced during the synthesis process, so atmospheric moisture becomes the sole water source influencing the final product's structure. The impregnation technique utilizing Sous vide effectively mitigates the contact between the synthesis solution and air or atmospheric water. The prompt sealing of the vacuum bag immediately after applying the vacuum helps prevent moisture from coming into contact with the synthesis solution. This airtight sealing promotes the preservation of the desired moisture-free environment throughout the impregnation process.

Analysis of the THO-impregnated carbon block using acid digestion and consequent ICP-MS analysis revealed a titanium content of 13±0.5 wt % as a result of the Sous vide impregnation process. This value agreed with the titanium loading obtained from XRF analysis as a secondary method. The titanium loading exhibited minimal variation, with a difference of less than 1% observed across nine distinct samples of the carbon block (i.e., 3 different spots at the top, middle, and bottom of the impregnated carbon block).

SEM images and EDX elemental mapping of titania obtained from nine different regions of the carbon block reveal that titanium particles are uniformly distributed throughout all sections of the filter. Matching the EDX elemental mapping with SEM images confirms the presence of THO particles within the macropores and channels of the carbon block, which serve as pathways for water flow. Not all surfaces of the activated carbon were covered by titanium materials, as these non-THO coated surfaces provide adsorption sites for the removal of organic contaminants. However, the size limitations of the Teflon vessel (diameter of 4.2 cm and height of 8 cm) restricted impregnation to small carbon block plugs, preventing full-scale impregnation of commercial carbon block samples. This size limitation was overcome by the Sous vide method, which exhibited robustness and enabled the impregnation of carbon block samples of any size. Overall, the Sous vide impregnation technique resulted in even titanium loading within the carbon block pores, with the uniform formation and distribution of THO particles achieved through the combined effects of vacuum and sealing and the homogenous heat transfer during the impregnation process.

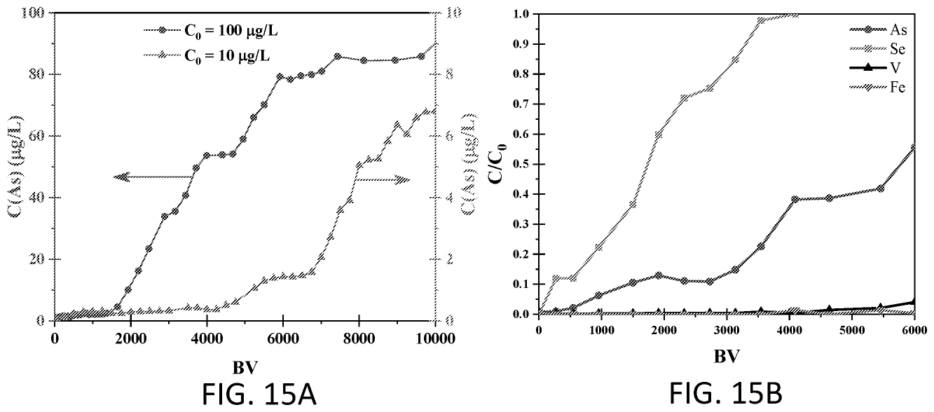

FIG. 15A illustrates the arsenate breakthrough curve obtained from treating 100 μg/L arsenic-spiked tap water using the THO-impregnated carbon block over the treatment of 10,000 bed volumes (BV). One bed volume corresponds to 0.48 liters of water for the full-sized carbon block utilized. During the initial 1,700 BV treatment, the THO carbon block demonstrated an arsenate removal efficiency exceeding 99%. A decrease in arsenate adsorption between 1,800 and 8,000 BV of treated water resulted in a breakthrough. Following the treatment of 10,000 BV of water, the cumulative amount of arsenate removed from the water, representing a reduced exposure burden if the water were to be used for drinking purposes, was determined to be 224 mg of arsenic. This value was determined by calculating the area above the breakthrough curve and considering the volume of each BV. Correspondingly, the adsorption capacity of the THO-impregnated carbon block was determined to be 4.6 mg As/g Ti or 0.6 mg As/g THO-carbon block after the treatment of 10,000 BV. The gradual shape of the breakthrough suggests that the impregnation was processed inside the macropores and channels rather than the micro and mesopores, which leads to an increased mass transfer coefficient. Comparable adsorption capacities and mass transfer zones indicate the effectiveness of the Sous vide method for scaling up the production of the THO-impregnated carbon block.

A minimal hydraulic pressure drop (<0.35 bar or <5 psi) was observed during the operation of either the non-treated or impregnated carbon block. This indicates that the impregnation process with THO using Sous vide did not cause any pore blockage in the carbon block, allowing water to flow through the pores without obstruction. Furthermore, continuous titanium (Ti) concentration monitoring during water flow showed no evidence of Ti leaching (i.e., <1 ppb). The homogeneous heating achieved during the aging step played a crucial role in the formation of THO particles inside the carbon block and their strong binding with the carbon surface, thereby preventing the leaching of Ti from the impregnated carbon block.

FIG. 15A shows the arsenate breakthrough curve obtained from treating 10 μg/L arsenic-spiked tap water using the THO-impregnated carbon block over the treatment of 10,000 BV. Over the first 5,000 BV treatment, the THO-impregnated carbon block removed more than 90% of the arsenate, lowering the arsenic concentration to below 1 μg/L in the effluent. Over 10,000 BV treatment of the 10 μg/L arsenic-spiked tap water, the THO-impregnated carbon block removed 37.6 mg of arsenic cumulatively, which corresponds to an adsorption capacity of 0.8 mg As/g Ti or 0.1 mg As/g THO-carbon block.

FIG. 15B illustrates the arsenic breakthrough curve obtained from treating groundwater containing 36 μg/L of ambient arsenic (100% arsenate) using the THO-impregnated carbon block. Over the course of treating the first ˜3,000 BV, more than 90% of the influent arsenic was successfully removed, demonstrating effective arsenic removal. Subsequently, a gradual breakthrough of arsenic occurred. After treating 6,000 BV of water, the THO carbon block achieved a total arsenic removal of 81 mg (corresponding to 1.7 mg As/g Ti or 0.2 mg As/g THO-carbon block). These values are comparable to the adsorption capacity observed in the arsenate-spiked tap water experiments with a 3 times higher influent arsenate concentration (4.6 mg As/g Ti or 0.6 mg As/g THO-carbon block) and 10,000 BV treatment. This indicates that the impregnated carbon block exhibits effective arsenic removal capabilities across different influent arsenic concentrations.

FIG. 15B demonstrates the simultaneous removal of arsenic, selenium, vanadium, and iron by the THO-impregnated carbon block. While selenium removal was not as efficient as arsenic removal, the THO carbon block achieved substantial removal of vanadium and iron. The removal of iron is advantageous for at least two reasons. Iron can contribute to aesthetic issues such as tap water color and staining. Additionally, the removal of iron by the THO carbon block may potentially enhance arsenic removal through the coprecipitation of arsenic with pre-existing iron present within the pores of the carbon block. The irregular shape of the breakthrough curve for arsenic may be attributed, in part, to the adsorption of arsenate onto the removed iron. Simultaneous removal of vanadium is another advantage of the Sous vide-prepared impregnated carbon block. Overall, Sous vide impregnation resulted in the proper formation of amorphous THO inside the carbon block pores, comparable to the THO formed through a conventional Teflon-sealed autoclave approach.

Sous vide impregnation addresses a critical need in terms of reducing chemical waste, resulting in a more affordable and environmentally friendly process. Table 5 provides a comparison of the total volume of chemicals required for impregnating a carbon block using the conventional autoclave method versus the Sous vide technique. Concerning the volume of the small 17 cm³ carbon block piece and a full-size carbon block filter (480 cm³), impregnation of the full-size carbon block via the conventional autoclave method requires 3,887 mL of synthesis solution. In contrast, Sous vide impregnation consumed only 1,150 mL of synthesis solution, which is 70% lower than the volume required for conventional impregnation. This reduction in chemical consumption translates to higher affordability and a more sustainable process. Overall, the Sous vide technique successfully produces a THO-impregnated carbon block with comparable arsenic removal performance to conventional impregnation, utilizing a 70% lower volume of precursor chemicals. This reduces both costs of the initial chemicals but also the costs and impacts of disposing of residual chemicals after the synthesis of the THO-impregnated carbon block is completed.

TABLE 5
Total chemicals consumption in each impregnation technique
for different volumes of the carbon block

| | Carbon block | Total chemicals |
|---|---|---|
| Impregnation method | volume (cm³) | consumption (mL) |
| Conventional autoclave method | 17 | 68.2 |
| Conventional autoclave method | 960 | 3,887 |
| with 2 full-size carbon blocks | | |
| Sous vide method with 2 full- | 960 | 1,150 |
| size carbon blocks | | |

Amorphous THO-impregnated carbon block modules have been demonstrated as reliable point-of-use (POU) filters for the effective removal of arsenic from drinking water, with no adverse effects on the hydraulic flow rate or leaching of precursor materials. THO-impregnated carbon block continued the ability to remove trace organics. The application of the Sous vide technique, by creating a vacuum environment, successfully eliminates trapped oxygen, allowing the synthesis solution to penetrate the carbon block pores. The absence of air and the homogenous reaction environment provided by the hot water bath contribute to the even distribution of THO particles with ˜13 wt % Ti within the carbon block pores without obstructing water pathways or causing a significant hydraulic pressure drop.

The modified carbon block demonstrates arsenic and other hazardous oxo-anions and metals from both spiked tap water and actual groundwater, comparable to conventional bench-scale autoclave methods. The appropriate sol-gel reaction progression inside the Sous vide vacuum bag results in a chemical binding between THO and the carbon surface, preventing Ti from leaching during water flow. Additionally, the Sous vide impregnation process reduces chemical consumption by 70%, offering a more sustainable and affordable approach for modifying carbon block filters with amorphous THO.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1. A composite material comprising:
an adsorbent support comprising a carbon block structure defining pores; and
titanium (hydr)oxide particles or films bound to the carbon block structure inside the pores.

2. The composite material of claim 1, wherein a content of titanium in the composite material is about 1 wt % to about 20 wt %.

3. The composite material of claim 2, wherein a content of titanium in the composite material is about 8 wt % to about 14 wt %.

4. The composite material of claim 1, wherein the titanium (hydr)oxide particles or films comprise amorphous titania.

5. The composite material of claim 4, wherein the titanium (hydr)oxide particles or films comprise about 55 wt % to about 99 wt % amorphous titania.

6. The composite material of claim 1, wherein the titanium (hydr)oxide particles or films are free of semi-crystalline and crystalline titania.

7. The composite material of claim 1, wherein the titanium (hydr)oxide particles or films are distributed throughout the carbon block structure.

8. The composite material of claim 1, wherein the titanium (hydr)oxide particles or films are chemically bound to the carbon block structure.

9. The composite material of claim 1, wherein at least a portion of a surface of the carbon block structure and its pores is free of titanium (hydr)oxide particles.

10. The composite material of claim 1, wherein the titanium (hydr)oxide particles or films have an average diameter or thickness in a range of about 1 nm to about 500 nm.

11. The composite material of claim 10, wherein the titanium (hydr)oxide particles or films have an average diameter or thickness in a range of about 20 nm to about 50 nm.

12. The composite material of claim 1, wherein a majority of the pores in the composite material have an average diameter greater than 2 nm and less than 50 nm.

13. The composite material of claim 1, wherein a pore volume of the composite material is between about 0.05 cm³/g and about 0.08 cm³/g, based upon BJH model fitting.

14. The composite material of claim 1, wherein a BET surface area of the composite material is between about 350 m²/g and about 450 m²/g.

15. The composite material of claim 1, wherein an arsenic adsorption capacity of the composite material is in a range of about 5 milligrams arsenic per gram of titanium to about 10 milligrams arsenic per gram of titanium.

16. The composite material of claim 1, further comprising cerium-titanium (hydr)oxide particles or films bound to the carbon block structure inside the pores.

17. A method of preparing composite material, the method comprising:
contacting a porous support comprising a carbon block structure defining pores with a solution comprising a solvent and a titanium (hydr)oxide precursor to yield a precursor material; and
drying the precursor material to yield a titanium (hydr)oxide-impregnated carbon block.

18. The method of claim 17, wherein the titanium (hydr)oxide precursor comprises titanium oxysulfate, titanium isopropoxide, or titanium butoxide.

19-28. (canceled)

29. A method of synthesizing hybrid titanium (hydr)oxides, the method comprising:
combining a solution comprising a titanium (hydr)oxide precursor and a solvent with one or more metal precursors to yield a precursor solution, wherein the one or more metal precursors comprise metal oxycations, metal isopropoxides, metal butoxides, metal salts, or a combination thereof; and
heating the precursor solution to yield the hybrid titanium (hydr)oxides.

30. The method of claim 29, wherein the one or more metal precursors comprise cerium precursors.

31-33. (canceled)
